(19) United States
(12) Patent Application Publication
(10) Pub. No.: US 2026/0265879 A1
(43) Pub. Date: Sep. 10, 2026

(54) BOLT

(71) Applicant: NIPPON STEEL CORPORATION, Tokyo (JP)

(72) Inventors: Yasuharu SHINKAI, Tokyo (JP); Makoto OKONOGI, Tokyo (JP); Daisuke HIRAKAMI, Tokyo (JP); Yutaka NEISHI, Tokyo (JP)

(21) Appl. No.: 19/160,901

(22) PCT Filed: Mar. 14, 2024
(86) PCT No.: PCT/JP2024/010018

§ 371 Date: Aug. 29, 2025

(30) Foreign Application Priority Data
Mar. 15, 2023 (JP) 2023-041287

(51) Int. Cl. C22C 38/02; B21C 23/01; B21C 37/00; C22C 38/04; C22C 38/06; C22C 38/14

(52) U.S. Cl. CPC C22C 38/02; B21C 23/01; B21C 37/00; C22C 38/04; C22C 38/06; C22C 38/14

(57) ABSTRACT

This bolt has a prescribed chemical composition and is provided such that when a diameter of a shaft portion is D, 95% or more of a metallographic structure at a D/4 position is a hard structure; when β_{C} is a full width at half maximum of a X-ray diffraction peak corresponding to a (211) plane of ferrite at a center of the shaft portion of a connection portion between a bolt head portion and the shaft portion and β_{MAX} is a maximum value of the full width at half maximum of the X-ray diffraction peak corresponding to the (211) plane of the ferrite in a region from a surface of the connection portion to a depth of 500 μm toward a central axis of the shaft portion, a ratio β_{MAX}/β_{C} is 1.50 or less; and a tensile strength is from 800 to 1700 MPa.

### TECHNICAL FIELD

The present invention relates to a bolt. The bolt according to the present invention relates particularly to a non-tempered bolt.

Priority is claimed on Japanese Patent Application No. 2023-041287, filed Mar. 15, 2023, the content of which is incorporated herein by reference.

### BACKGROUND ART

In the fields of various machines such as automobiles and civil engineering and construction, high-strength bolts having a tensile strength of 800 MPa or more are used from the viewpoint of weight reduction, size reduction, cost reduction, and the like. However, it is generally known that hydrogen embrittlement easily occurs in high-strength bolts, and it is desirable to improve hydrogen embrittlement resistance together with strength in order to achieve high strength of the bolts.

As a method for improving hydrogen embrittlement resistance of a high-strength component such as a high-strength bolt, a method has been known in which the structure is formed into a pearlite structure or a bainite structure and the structure is reinforced by wire drawing, and many proposals have been made so far (e.g., Patent Documents 1 to 5).

However, in order to further improve the space efficiency, it is desired to further increase the strength of the bolt, and in particular, in order to cope with the increase in the strength of a non-tempered bolt, only the conventional technique alone may be insufficient.

As a method for producing a high-strength bolt having a tensile strength of 800 MPa or more, for example, there is a method for producing a high-strength bolt by forming a steel wire made of alloy steel containing alloy elements such as Cr, Mo, and/or V into a given shape and then performing quenching and tempering treatment. Unfortunately, this method is disadvantageous in terms of heat treatment cost and thus production cost.

On the other hand, in order to reduce the production cost, a method has been known that produces a high-strength bolt to which predetermined strength is imparted by omitting quenching and tempering after forming and applying a wire drawing process to a wire rod having strength increased by rapid cooling, precipitation strengthening, or the like. The bolt produced by this method is called a non-tempered bolt.

For example, in a non-tempered bolt produced by cold-working a steel wire reinforced by wire-drawing a pearlite structure or a bainite structure, it is considered that hydrogen is trapped at an interface between cementite and ferrite inside the pearlite structure or the bainite structure. Accordingly, entry of hydrogen into the inside of the steel material is suppressed, and hydrogen embrittlement resistance is thus improved. However, it is not easy to sufficiently improve hydrogen embrittlement resistance only by this technique, and further improvement is desired.

As a method for producing a non-tempered bolt, Patent Document 6 describes a bolt heading method including preliminarily forming a rod-shaped metal material to form a bolt preliminary formed material, the pressing side of which is expanded, and then forming the bolt preliminary formed material such that the volume of a shaft portion thereof becomes larger than that of a shaft portion of the resulting bolt formation-finished material. Unfortunately, even the bolt produced by the method of Patent Document 6 has insufficient hydrogen embrittlement resistance.

### CITATION LIST

### Patent Document

Patent Document 1: Japanese Unexamined Patent Application, First Publication No. H11-315348
Patent Document 2: Japanese Unexamined Patent Application, First Publication No. 2001-348618
Patent Document 3: Japanese Unexamined Patent Application, First Publication No. 2005-281860
Patent Document 4: PCT International Publication No. WO 2016/121820
Patent Document 5: PCT International Publication No. WO 2017/122830
Patent Document 6: Japanese Unexamined Patent Application, First Publication No. 2007-136460

### SUMMARY OF INVENTION

### Technical Problem

The present invention has been made in view of the above circumstances, and an object of the present invention is to provide a bolt having a tensile strength of 800 MPa to 1700 MPa and exceptional hydrogen embrittlement resistance.

### Solution to Problem

The gist of the present invention is as follows.
[1] A bolt having a chemical composition including, in mass %,
C: 0.18 to 0.80%,
Si: 0.01 to 1.50%,
Mn: 0.50 to 2.00%,
Al: 0.005 to 0.080%,
P: 0.030% or less,
S: 0.030% or less,
Ti: 0.005 to 0.100%,
B: 0.0003 to 0.0050%,
N: 0.0150% or less,
O: 0.0100% or less, and
a balance: Fe and impurities, wherein
when a diameter of a shaft portion is D, 95% or more of a metallographic structure at a D/4 position is a hard structure;
when β_{C} is a full width at half maximum of a X-ray diffraction peak corresponding to a (211) plane of ferrite at a center of the shaft portion of a connection portion between a bolt head portion and the shaft portion and β_{MAX} is a maximum value of the full width at half maximum of the X-ray diffraction peak corresponding to the (211) plane of the ferrite in a region from a surface of the connection portion to a depth of 500 μm toward a central axis of the shaft portion, a ratio β_{MAX}/β_{C} is 1.50 or less; and.
a tensile strength is from 800 to 1700 MPa.
[2] A bolt having a chemical composition including, in mass %,
C: 0.18 to 0.80%,
Si: 0.01 to 1.50%,
Mn: 0.50 to 2.00%,
Al: 0.005 to 0.080%,
P: 0.030% or less,
S: 0.030% or less,
Ti: 0.005 to 0.100%;
B: 0.0003 to 0.0050%,
N: 0.0150% or less, and
O: 0.0100% or less,
the composition further including
one or two or more elements selected from the group consisting of group A, group B, and group C below,
with a balance consisting of Fe and impurities, wherein
when a diameter of a shaft portion is D, 95% or more of a metallographic structure at a D/4 position is a hard structure;
when β_{C} is a full width at half maximum of a X-ray diffraction peak corresponding to a (211) plane of ferrite at a center of the shaft portion of a connection portion between a bolt head portion and the shaft portion and β_{MAX} is a maximum value of the full width at half maximum of the X-ray diffraction peak corresponding to the (211) plane of the ferrite in a region from a surface of the connection portion to a depth of 500 μm toward a central axis of the shaft portion, a ratio β_{MAX}/β_{C} is 1.50 or less; and
a tensile strength is from 800 to 1700 MPa:
[group A] one or two or more elements selected from the group consisting of Cr: 1.50% or less, Mo: 0.50% or less, Nb: 0.050% or less, V: 0.20% or less, and W: 0.20% or less;
[group B] one or two elements selected from the group consisting of Cu: 0.50% or less and Ni: 0.50% or less; and
[group C] one or two or more elements selected from the group consisting of Ca: 0.0100% or less, Mg: 0.0100% or less, Ce: 0.020% or less, and Sn: 0.0400% or less.
[3] The bolt according to [2], having the chemical composition including the group A in mass %.
[4] The bolt according to [2], having the chemical composition including the group B in mass %.
[5] The bolt according to [2], having the chemical composition including the group C in mass %.

### Advantageous Effects of Invention

The present invention can provide a bolt having a tensile strength of 800 MPa to 1700 MPa and exceptional hydrogen embrittlement resistance.

### BRIEF DESCRIPTION OF DRAWINGS

FIG. 1 is a schematic cross-sectional view of a shaft portion to illustrate a position of measuring an area fraction of a steel hard structure of a bolt according to an embodiment of the present invention.

FIG. 2 is a view illustrating a position of measuring β_{MAX}/β_{C} in modification embodiment 1 of the bolt according to the embodiment of the present invention, and is a schematic cross-sectional view including a center axis of a shaft portion in the vicinity of a connection portion between a bolt head portion and the shaft portion.

FIG. 3 is a view illustrating a position of measuring β_{MAX}/βC of a bolt according to an embodiment of the present invention, and is a schematic cross-sectional view including a center axis of a shaft portion in the vicinity of a connection portion between a bolt head portion and the shaft portion.

FIG. 4 is a view illustrating a position of measuring β_{MAX}/β_{C} in modification embodiment 2 of the bolt according to the embodiment of the present invention and is a schematic cross-sectional view including a center axis of a shaft portion in the vicinity of a connection portion between a bolt head portion and the shaft portion.

FIG. 5 is a process diagram for explaining step 1 of a method for producing a bolt according to an embodiment of the present invention.

FIG. 6 is a process diagram for explaining step 2 of the method for producing a bolt according to the embodiment of the present invention.

FIG. 7 is a process diagram for explaining step 3 of the method for producing a bolt according to the embodiment of the present invention.

### DESCRIPTION OF EMBODIMENTS

Hereinafter, a bolt according to an embodiment of the present invention will be described in detail.

The bolt according to an embodiment of the present invention is a bolt having a chemical composition including, in mass %,
C: 0.18 to 0.80%,
Si: 0.01 to 1.50%,
Mn: 0.50 to 2.00%,
Al: 0.005 to 0.080%,
P: 0.030% or less,
S: 0.030% or less,
Ti: 0.005 to 0.100%,
B: 0.0003 to 0.0050%,
N: 0.0150% or less,
O: 0.0100% or less, and
a balance: Fe and impurities, wherein
when a diameter of a shaft portion is D, 95% or more of a metallographic structure at a D/4 position is a hard structure;
when β_{C} is a full width at half maximum of a X-ray diffraction peak corresponding to a (211) plane of ferrite at a center of the shaft portion of a connection portion between a bolt head portion and the shaft portion and β_{MAX} is a maximum value of the full width at half maximum of the X-ray diffraction peak corresponding to the (211) plane of the ferrite in a region from a surface of the connection portion to a depth of 500 μm toward a central axis of the shaft portion, a ratio β_{MAX}/β_{C} is 1.50 or less; and
a tensile strength is from 800 to 1700 MPa.

In the case of a heat-treated bolt, the full width at half maximum of the X-ray diffraction peak corresponding to the (211) plane of ferrite does not change in measurement at any position of a bolt head portion or in the vicinity of a connection portion between the bolt head portion and the shaft portion (provided that in the case of a bolt obtained by heat treatment, followed by rolling to form a thread portion, the full width at half maximum of the X-ray diffraction peak corresponding to the (211) plane of ferrite may change around the thread portion). In the bolt of the present disclosure, the full width at half maximum of the X-ray diffraction peak corresponding to the (211) plane of ferrite changes depending on the position to be measured due to the influence of processing.

### <<Chemical Composition>>

The following describes the chemical composition of steel in a bolt according to an embodiment of the present invention. In the following description, the expression “%” of the content of each element in a chemical composition means “mass %”, In addition, a numerical range represented by “to” means a range including numerical values described before and after “to” as the lower limit and the upper limit. Note that a numerical range in which “more than” or “less than” is attached to the numerical values described before and after “to” means a range not including these numerical values as the lower limit or the upper limit.

### [C: 0.18% to 0.80%]

C is an element necessary for ensuring a tensile strength. When the C content is less than 0.18%, it is difficult to obtain a desired tensile strength. Thus, the lower limit of the C content is set to 0.18% or more, and preferably 0.20% or more. In addition, when the C content is more than 0.80%, cold workability is deteriorated. Thus, the upper limit of the C content is set to 0.80% or less, and preferably 0.75% or less.

### [Si: 0.01 to 1.50%]

Si (silicon) is a deoxidizing element and is an element that increases the tensile strength by solid solution reinforcement. When the Si content is less than 0.010%, the effect of including Si is insufficiently exhibited. Thus, the lower limit of Si content is set to 0.01% or more, and preferably 0.05% or more. In addition, when the Si content is more than 1.50%, the effect of including Si is saturated, and ductility during hot rolling is deteriorated, so that surface defects are likely to occur. Due to the surface defects, cold workability may be deteriorated. Thus, the upper limit of Si content is set to 1.50% or less, and preferably 1.00% or less.

### [Mn: 0.50 to 2.00%]

Mn (manganese) is an element that promotes transformation to a hard structure (bainite transformation) and increases the tensile strength of steel. When the Mn content is less than 0.50%, the effect of including Mn is insufficiently exhibited. Thus, the lower limit of Mn content is set to 0.50% or more, and preferably 0.60% or more. In addition, when the Mn content is more than 2.00%, a martensite structure is locally formed, and the cold workability may be deteriorated. Thus, the upper limit of Mn content is set to 2.00% or less, and preferably is 1.50% or less.

### [Al: 0.005 to 0.080%]

Al (aluminum) is a deoxidizing element and is an element that forms AlN functioning as pinning particles. AlN makes the grains finer, thereby enhancing cold workability. In addition, Al is an element having an action of reducing the solid solution N to suppress dynamic strain ageing and an action of enhancing hydrogen embrittlement resistance. Thus, the Al content is set to 0.005% or more, and preferably 0.010% or more. In addition, when the Al content is more than 0.080%, the above-described effect is saturated, and a coarse oxide such as Al₂O₃ is formed, which may cause fatigue fracture. Thus, the upper limit of Al content is set to 0.080% or less, and preferably 0.060% or less.

### [P: 0.030% or Less]

P (phosphorus) is an impurity element inevitably mixed in steel and is an element that segregates at grain boundaries to deteriorate hydrogen embrittlement resistance and deteriorate cold workability. Since the bolt according to the present embodiment does not need to contain P, the lower limit of P content is 0%. However, from the viewpoint of reducing the manufacturing cost (dephosphorization cost), the P content may be more than 0%, 0.002% or more, or 0.005% or more. When the P content is more than 0.030%, deterioration of hydrogen embrittlement resistance and deterioration of cold workability are marked. Thus, the P content is limited to 0.030% or less, and preferably 0.015% or less.

### [S: 0.030% or Less]

S (sulfur) is, like P, an impurity element inevitably mixed in steel and is an element that segregates at grain boundaries to deteriorate hydrogen embrittlement resistance and deteriorate cold workability. Since the bolt according to the present embodiment does not need to contain S, the lower limit of S content is 0%. However, from the viewpoint of reducing the manufacturing cost (desulfurization cost), the S content may be more than 0%, 0.002% or more, or 0.005% or more. When the S content is more than 0.030%, deterioration of hydrogen embrittlement resistance and deterioration of cold workability are marked. Thus, the S content is limited to 0.030% or less, preferably 0.015% or less, and more preferably 0.010% or less.

### [Ti: 0.005 to 0.100%]

Ti (titanium) is a deoxidizing element and is an element that forms TIN functioning as pinning particles. In addition, Ti is an element having an action of reducing the solid solution N to suppress dynamic strain ageing and an action of enhancing hydrogen embrittlement resistance. In addition, there is an effect of suppressing the generation of BN in steel. When the Ti content is less than 0.005%, degradation of cold workability due to dynamic strain ageing, degradation of hydrogen embrittlement resistance, and excessive generation of BN in steel may occur. Thus, the lower limit of Ti content is set to 0.005% or more and preferably 0.007% or more, and more preferably 0.0010% or more. On the other hand, when the Ti content is more than 0.100%, the above effect is saturated and defects during hot rolling are likely to occur. Thus, the Ti content is set to 0.100% or less, and preferably 0.080% or less, and more preferably 0.040% or less.

### [B: 0.0003 to 0.0050%]

B (boron) is an element that promotes transformation to a hard structure (bainite transformation) and increases the tensile strength. When the B content is less than 0.0003%, transformation to a hard structure (bainite transformation) is not promoted, and a pro-eutectoid ferrite structure or a pearlite structure may be excessively generated during isothermal transformation treatments. Thus, the lower limit of B content is set to 0,0003% or more and preferably 0.0005% or more, and more preferably 0.0007% or more. On the other hand, when the B content is more than 0.0050%, BN, Fe₂₃(BC)₆, and the like are generated in the steel, and the cold workability may be deteriorated. Thus, the B content is 0.0050% or less, and preferably 0.0030% or less.

### [N: 0.0150% or Less]

N (nitrogen) is an element that deteriorates cold workability due to dynamic strain ageing. Since the bolt according to the present embodiment does not need to contain N, the lower limit of N content is 0%. However, from the viewpoint of reducing the manufacturing cost (denitrification cost), the N content may be more than 0%, 0.0002% or more, or 0.0005% or more. When the N content is more than 0.0150%, degradation of cold workability due to dynamic strain ageing is marked. Thus, the N content is limited to 0.0150% or less, and preferably 0.0040% or less.

### [O: 0.0100% or Less]

O (oxygen) is an impurity element inevitably mixed in steel, and exists in steel as an oxide of, for instance, Al and Ti or the like. Since the bolt according to the present embodiment does not need to contain O, the lower limit of O content is 0%. However, from the viewpoint of reducing the manufacturing cost (deoxidizing cost), the O content may be more than 0%, 0.0002% or more, or 0.0005% or more. When the O content is more than 0.0100%, coarse oxides are generated in the steel, and fatigue fracture is likely to occur. Thus, the O content is set to 0.0100% or less, and preferably 0.0050% or less.

### [Balance: Fe and Impurities]

In the chemical composition of the steel of the bolt according to the present embodiment, a balance excluding the above elements is Fe and impurities. Here, the impurities refer to components that are contained in a raw material or mixed in a manufacturing step and not intentionally included in the steel.

Note that the chemical composition of the steel of the bolt according to the present embodiment may contain, in place of a portion of Fe, one or two or more elements selected from the group consisting of the following group A, group B, and group C:
[group A] one or two or more elements selected from the group consisting of Cr: 1.50% or less, Mo: 0.50% or less, Nb: 0.050% or less, V: 0.20% or less, and W: 0.20% or less;
[group B] one or two elements selected from the group consisting of Cu: 0.50% or less and Ni: 0.50% or less; and
[group C] one or two or more elements selected from the group consisting of Ca: 0.0100% or less, Mg: 0.0100% or less, Ce: 0.020% or less, and Sn: 0.0400% or less.

### As to [Group A]

The chemical composition of the steel of the bolt of the present embodiment may contain, in place of a portion of Fe, one or two or more elements selected from Cr, Mo, Nb, V, and W in mass %. These elements are elements that promote transformation to a hard structure (bainite transformation) and increase the tensile strength.

### [Cr: 1.50% or Less]

Cr (chromium) is an optional element and is an element that promotes transformation to a hard structure (bainite transformation) and increases the tensile strength of steel. In order to elicit the effect of including Cr, the content is more preferably 0.02% or more, still more preferably 0.03% or more, still more preferably 0.05% or more, and particularly preferably 0.10% or more. On the other hand, when the Cr content is more than 1.50%, a martensite structure is locally formed, and the cold workability may be deteriorated. Thus, the Cr content is set to 1.50% or less, and preferably 1.30% or less, and more preferably 1.00% or less.

### [Mo: 0.50% or Less]

Mo (molybdenum) is an optional element and is an element, like Cr, that promotes transformation to a hard structure (bainite transformation) and increases the tensile strength of steel. In order to elicit the effect of including Mo, the content is more preferably 0.02% or more, still more preferably 0.03% or more, still more preferably 0.05% or more, and particularly preferably 0.10% or more. On the other hand, when the Mo content is more than 0.50%, martensite is locally formed, and the cold workability may be deteriorated. Thus, the Mo content is set to 0.50% or less, and preferably 0.40% or less, and more preferably 0.35% or less.

### [Nb: 0.050% or Less]

Nb (niobium) is an optional element and is an element that promotes transformation to a hard structure (bainite transformation) and increases the tensile strength. In order to elicit the effect of including Nb, the content is preferably 0.002% or more. On the other hand, when the Nb content is more than 0.050%, the hot ductility of steel decreases, and surface defects are likely to occur during wire rod rolling. Due to the surface defects, cold workability may be deteriorated. Thus, the Nb content is set t to 0.050% or less, and preferably 0.040% or less.

### [V: 0.20% or Less]

V (vanadium) is an optional element and is an element that promotes transformation to a hard structure (bainite transformation) and increases the tensile strength, From the viewpoint of obtaining these effects, the V content is preferably more than 0% or 0.02% or more, and more preferably 0.04% or more. On the other hand, when the V content is more than 0.20%, the hot ductility of steel decreases, and surface defects are likely to occur during wire rod rolling. Due to the surface defects, cold workability may be deteriorated. Thus, the V content is set to 0.20% or less, and preferably 0.15% or less.

### [W: 0.20% or Less]

W (tungsten) is an optional element and is an element that promotes transformation to a hard structure (bainite transformation) and increases the tensile strength. From the viewpoint of obtaining these effects, the W content is preferably more than 0% or 0.02% or more, and more preferably 0.04% or more. On the other hand, when the W content is more than 0.20%, the hot ductility of steel decreases, and surface defects are likely to occur during wire rod rolling. Due to the surface defects, cold workability may be deteriorated. Thus, the W content is set to 0.20% or less, and preferably 0.15% or less.

### As to [Group B]

In addition, the chemical composition of the steel of the bolt of the present embodiment may contain, in place of a portion of Fe, one or two elements selected from Cu and Ni.

### [Cu: 0.50% or Less]

Cu (copper) is an optional element and may be included when it is desired to improve hydrogen embrittlement resistance. Cu may be more than 0% or 0.02% or more. On the other hand, when the Cu content is more than 0.50%, the hot ductility of steel decreases, and surface defects are likely to occur during wire rod rolling. Due to the surface defects, cold workability may be deteriorated. Thus, the Cu content is set to 0.50% or less, and preferably 0.35% or less.

### [Ni: 0.50% or Less]

Ni (nickel) is an optional element. When Cu is included, Ni may also be included in order to suppress a decrease in hot ductility of the steel material due to Cu. Ni may be more than 0% or 0.02% or more. On the other hand, when the Ni content is more than 0.50%, the hot ductility of steel decreases, and surface defects are likely to occur during wire rod rolling. Due to the surface defects, cold workability may be deteriorated. Thus, the Ni content is set to 0.50% or less, and preferably 0.35% or less.

### As to [Group C]

Further, the chemical composition of the steel of the bolt of the present embodiment may contain, in place of a portion of Fe, one or two or more elements selected from Ca, Mg, and Sn.

### [Ca: 0.0100% or Less]

Ca (calcium) is an optional element. Ca is a deoxidizing element and has an effect of spheroidizing the shape of MnS in steel to improve cold workability and machinability, and may thus be included when it is desired to improve these characteristics. Ca may be more than 0%, 0.0002% or more, or 0.0005% or more. On the other hand, when the Ca content is more than 0.0100%, the Ca-based intermediate is easily mixed into the steel, and the cold workability may be deteriorated. Thus, the Ca content is set to 0.0100% or less, and preferably 0.0050% or less.

### [Mg: 0.0100% or Less]

Mg (magnesium) is an optional element. Mg is a deoxidizing element, and has an effect of spheroidizing the shape of MnS in steel material to improve cold workability and machinability, and may thus be added when it is desired to improve these characteristics. Mg may be more than 0%, 0.0002% or more, or 0.0005% or more. On the other hand, when the Mg content is more than 0.0100%, the Mg-based intermediate is easily mixed into the steel, and the cold workability may be deteriorated. Thus, the Mg content is set to 0.0100% or less, and preferably 0.0050% or less.

### [Ce: 0.020% or Less]

Ce (cerium) is an optional element. Ce is a deoxidizing element, and has an effect of spheroidizing the shape of MnS in steel material to improve cold workability and machinability, and may thus be added when it is desired to improve these characteristics. Ce may be more than 0%, 0.002% or more, or 0.005% or more. On the other hand, when the Ce content is more than 0.020%, the Ce-based intermediate is easily mixed into the steel, and the cold workability may be deteriorated. Thus, the Ce content is set to 0.020% or less, and preferably 0.015% or less.

### [Sn: 0.0400% or Less]

Sn (tin) is an optional element. Since Sn has an effect of improving corrosion resistance, Sn may be included when it is desired to improve corrosion resistance. Sn may be more than 0%, 0.0002% or more, or 0.0005% or more. On the other hand, when the Sn content is more than 0.0400%, the hot ductility of steel decreases, and surface defects are likely to occur during wire rod rolling. Due to the surface defects, cold workability may be deteriorated. Thus, the Sn content is set to 0.0400% or less, and preferably 0.0200% or less.

### <<Metallographic Structure>>

Next, the metallographic structure will be described. In the metallographic structure of the steel of the bolt according to the present embodiment, 95% or more of the metallographic structure at a D/4 position deep from the shaft portion surface, in a case where the shaft portion diameter of the bolt is D, is a hard structure in the C-section of the shaft portion (cross section perpendicular to the center axis of the shaft portion).

Further, the bolt according to the present embodiment is provided such that when β_{C} is a full width at half maximum of a X-ray diffraction peak corresponding to a (211) plane of ferrite at the center of the shaft portion and β_{MAX} is a maximum value of the full width at half maximum of the X-ray diffraction peak corresponding to the (211) plane of the ferrite in a region from a surface layer of the shaft portion to a depth of 500 μm, a ratio β_{MAX}/β_{C} is 1.50 or less.

### (Hard Structure)

The hard structure is a supercooling transformation structure and is a structure obtained by isothermal transformation treatment. The hard structure is observed as a structure composed of ferrite in which carbide is dispersed when observed under a scanning electron microscope. The hard structure may also be referred to as a bainite structure. The hard structure does not have a pearlite structure, namely a lamellar structure of carbide and ferrite. In addition, no martensite structure is included in the hard structure in the present invention.

Note that in the microstructure of the steel material of the present embodiment, a structure other than the martensite structure, the pro-eutectoid ferrite structure, and the pearlite structure is defined as a “hard structure”. At that time, if the area fraction of the hard structure in the microstructure is 95% or more and the tensile strength of the steel of the bolt is from 800 to 1700 MPa, the microstructure of the steel of the bolt is substantially the hard structure.

The hard structure has high strength and exceptional workability. This improves the strength and cold workability of the steel of the bolt. Since the metallographic structure of the steel of the bolt according to the present embodiment is continuously cooled after hot rolling and then subjected to isothermal transformation treatment, the steel may include a pro-eutectoid ferrite structure and a pearlite structure in addition to the hard structure. The pro-eutectoid ferrite structure and the pearlite structure are clearly distinguished from the hard structure by observation under a scanning electron microscope. When the area fraction of the pro-eutectoid ferrite structure and the pearlite structure is more than 5%, the metallographic structure becomes non-uniform, so that cracking is likely to occur at the time of heading to shape the bolt. Therefore, the pro-eutectoid ferrite structure and the pearlite structure are desirably 5% or less and more preferably 1% or less, and may be 0%. In addition, when the martensite structure is included in the metallographic structure, cracking is likely to occur at the time of heading to shape the bolt. Thus, the metallographic structure should not contain any martensite structure. Martensite is observed as a white structure by scanning electron microscopy and is clearly distinguished from a hard structure.

### (Method of Measuring Area Fraction of Hard Structure)

The area fraction (%) of the hard structure herein refers to a value obtained by the following procedure.

A C-section (a cross section perpendicular to the bolt axis direction) of the shaft portion of the bolt is etched for 10 seconds using Picral (a solution obtained by mixing 4 g of picric acid with 100 ml of ethanol) to reveal a metallographic structure. When it is difficult to determine the structure, etching within 10 seconds may be further added.

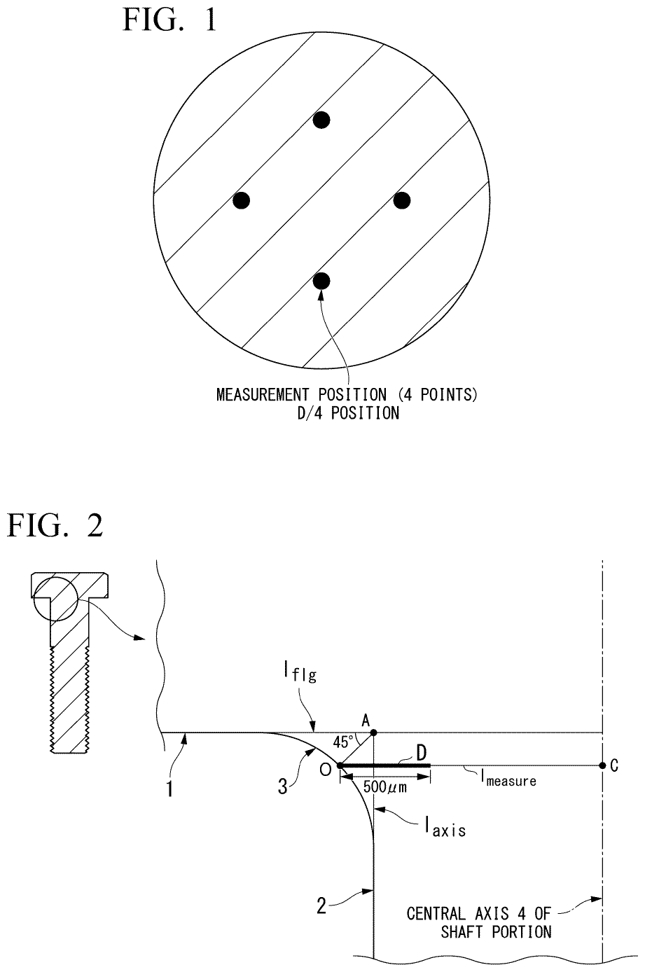

Next, as illustrated in FIG. 1, four observation positions are selected at intervals of 90° in the circumferential direction from a D/4 position (i.e., a circumferential position) deep from the surface of the shaft portion in the C-section of the post-etching shaft portion, and an SEM photograph at a magnification of 1000× is taken for each observation position using a FE-SEM (Field Emission-Scanning Electron Microscope).

In the obtained four SEM photographs, a structure (pro-eutectoid ferrite structure and pearlite structure) other than the hard structure is visually marked, and an area fraction (%) of the structure other than the hard structure based on the entire metallographic structure is calculated by image analysis. The area fraction (%) of the hard structure can be obtained by subtracting the obtained area fraction (%) of the structure other than the hard structure from 100%. Note that the C-section of the shaft portion of the bolt is positioned at a C-section of the shaft portion at a position 7 mm away from the bolt seat surface along the bolt axis direction. When no structure other than the hard structure is found, the area fraction of the hard structure may be 100%.

(β_{MAX}/β_{C})

The bolt according to the present embodiment is provided such that when β_{C} is a full width at half maximum of a X-ray diffraction peak corresponding to a (211) plane of ferrite at the center of the shaft portion of a connection portion between a bolt head portion and the shaft portion and MAX is a maximum value of the full width at half maximum of the X-ray diffraction peak corresponding to the (211) plane of the ferrite in a region from a surface of the connection portion to a depth of 500 μm toward a central axis of the shaft portion, a ratio β_{MAX}/β_{C} is 1.50 or less. As a result of intensive studies to improve hydrogen embrittlement resistance of the bolt, the present inventors have found a correlation between the full width at half maximum of the X-ray diffraction peak of the ferrite and hydrogen embrittlement resistance. More specifically, it has been found that when β_{MAX}/β_{C} is 1.50 or less, hydrogen embrittlement resistance of the bolt is exceptional.

When β_{MAX}/β_{C} is more than 1.50, hydrogen embrittlement resistance of the bolt is insufficient, and breakage due to hydrogen embrittlement is likely to occur. The β_{MAX}/β_{C} is preferably 1.40 or less and more preferably 1.35 or less. On the other hand, the lower limit of β_{MAX}/Be is not particularly defined but is preferably 0.50 or more from the viewpoint of manufacturability. In addition, the lower limit of β_{MAX}/β_{C} may be 0.70 or more, or may be 0.80 or more.

### (Measurement Position and Measurement Method for Full Width at Half Maximum of X-Ray Diffraction Peak)

The full width at half maximum β_{C}, which is the denominator of β_{MAX}/β_{C}, is measured at the center of the shaft portion of the connection portion between the bolt head portion and the shaft portion. In addition, β_{MAX}, which is a numerator of β_{MAX}/β_{C}, is a maximum value among each full width at half maximum of the X-ray diffraction peak measured at a plurality of locations in a region up to a depth of 500 μm from the surface of the connection portion between the bolt head portion and the shaft portion toward the central axis of the shaft portion. The bolt according to the present embodiment is what is called a non-tempered bolt, and strain introduced during cold working for finishing the bolt into a bolt shape remains in the bolt. Thus, the full width at half maximum of the X-ray diffraction peak may greatly change depending on the measurement position. The reason why the ratio of the full width at half maximum of the X-ray diffraction peak is measured at the connection portion is that the connection portion between the bolt head portion and the shaft portion is likely to be subjected to stress concentration and is likely to be a starting point of delayed fracture due to hydrogen embrittlement. It has been found that the hydrogen embrittlement resistance can be improved by controlling the ratio of the full width at half maximum of the X-ray diffraction peak at the connection portion. Hereinafter, measurement positions are described with reference to the drawings.

FIG. 2 is a schematic cross-sectional view for explaining positions of measuring the full width at half maximum β_{MAX} and the full width at half maximum β_{C}. FIG. 2 illustrates an L-section (cross section parallel to the bolt axis direction) which is a cross section in the vicinity of the connection portion between the bolt head portion and the shaft portion and includes the center axis of the shaft portion.

First, in FIG. 2, reference numeral 1 denotes a contour line of a bearing surface of a bolt in an L-section, reference numeral 2 denotes a contour line of a cylindrical portion in the L-section, and reference numeral 3 denotes a contour line of a surface of a connection portion between a bolt head portion and a shaft portion. Note that the contour line of the cylindrical portion in the case of the full-thread bolt is the contour of the incomplete thread portion. The contour line 1 of the lower surface of the bolt head portion and the contour line 2 of the surface of the shaft portion are directed in directions intersecting each other. Here, the bearing surface of the bolt refers to a portion of a surface that directly receives a force when the thread part is fastened (except a flank surface of the thread). The cylindrical portion refers to a cylindrical portion between the bolt head portion and the thread portion of the external thread part. In the example of FIG. 2, the contour line 1 and the contour line 2 of the surface of the shaft portion are substantially orthogonal to each other but are not necessarily orthogonal to each other as illustrated in another example to be described later. In addition, since the connection portion between the lower surface of the bolt head portion and the surface of the shaft portion is a minute R surface, the contour line 3 of the surface of the connection portion can be approximately represented by a concave curve so as to connect the contour lines 1 and 2 extending in the intersecting direction.

Here, an extension line of the contour line 1 of the lower surface of the bolt head portion is defined as l_{flg}, an extension line of the contour line 2 of the surface of the shaft portion is defined as lₐₓᵢₛ, and an intersection point of the extension line l_{flg} and the extension line lₐₓᵢₛ is defined as A.

Next, as illustrated in FIG. 2, a line segment is drawn from the intersection point A toward the contour line 3 on the surface of the connection portion, and the point of intersection between the line segment and the contour line 3 is defined as O. The line segment drawn from the intersection point A toward the contour line 3 is such a line segment that the angle formed with the extension line l_{flg} is 45°.

Next, as illustrated in FIG. 2, an extension line lₘₑₐₛᵤᵣₑ parallel to the extension line l_{flg} extends from the intersection point O toward the central axis 4 of the shaft portion. A point of intersection between the extension line lₘₑₐₛᵤᵣₑ and the central axis 4 is defined as C.

Then, as shown in FIG. 2, the intersection point C is set as a position of measuring the full width at half maximum β_{C}. In addition, as shown in FIG. 2, a region D from the intersection point O to a depth of 500 μm along the extension line lₘₑₐₛᵤᵣₑ is defined as a measurement region of the full width at half maximum β_{MAX}.

As shown in FIG. 2, the L-section of the connection portion including the center axis of the bolt, which section is a cross section in the vicinity of the connection portion between the bolt head portion and the shaft portion, is mirror-finished as described later. Then, X-ray diffraction is measured at the intersection point C in FIG. 2, and the full width half maximum (meaning FWHM) of the X-ray diffraction peak corresponding to the (211) plane of the ferrite is measured at the intersection point C. The X-ray diffraction is measured five times. The average of five values of the full width at half maximum obtained by five measurements is defined as a full width at half maximum β_{C}.

Further, as shown in FIG. 2, five measurement positions are set from a region D up to a depth of 500 μm along the extension line lₘₑₐₛᵤᵣₑₛ For example, five points away from the intersection point O by 100 μm, 200 μm, 300 μm, 400 μm, and 500 μm are set as measurement positions, and at each measurement position, the full width half maximum (meaning FWHM) of the X-ray diffraction peak corresponding to the (211) plane of the ferrite is measured. The X-ray diffraction is measured five times at each measurement point, and the average of the five times is defined as a full width at half maximum at each measurement position. The maximum full width at half maximum among each full width at half maximum as obtained at the five measurement positions is defined as a full width at half maximum β_{MAX}.

Then, a ratio β_{MAX}/β_{C} of the maximum full width at half maximum β_{MAX} to the full width at half maximum β_{C} is obtained.

The ferrite to be measured is mainly contained in a hard structure and refers to α-Fe having a body-centered cubic structure. More specifically, it is a portion other than carbide constituting the hard structure (sometimes referred to as bainitic ferrite), In addition, the X-ray diffraction peak for the (211) plane of the ferrite is an X-ray diffraction peak having a peak position within a range of 150 to 170° when X-ray diffraction is measured under the conditions below.

The diffraction profile obtained by X-ray diffraction measurement is pretreated by the following procedure. Hereinafter, it is assumed that no X-ray diffraction peak other than the X-ray diffraction peak corresponding to the (211) plane of the ferrite is included in the measurement section of the X-ray diffraction measurement.

Smoothing processing is performed on the obtained diffraction profile by the Savitsky-Golay method (A. Savitzky and M. J. E. Golay, Anal. Chem., 36 (1964), p. 1627-1639). The number of smoothing points (corresponding to a value of 2m+1 in Savitzky and Golay (1964)) is set to 7.

Subsequently, the intensities at the scanning start angle and the scanning end angle of the X-ray diffraction measurement are used to connect the measurement start angle and the measurement end angle by a straight line, and the straight line is subtracted, as the background, from the smoothed diffraction profile. For the background-subtracted diffraction profile, the Rachinger method (Rachinger, W. A., J. Sci. Instrum., 25 (1948), p. 254-255.) is applied to remove the X-ray diffraction peak corresponding to the Kα₂ ray from the X-ray diffraction peak corresponding to the (211) plane of the ferrite in the background-subtracted diffraction profile. The intensity ratio between the X-ray diffraction peak corresponding to the Kα₁ ray and the X-ray diffraction peak corresponding to the Kα₂ ray was set to 2:1. From the diffraction profile obtained from the above procedure, the FWHM is calculated and taken as the full width at half maximum of the X-ray diffraction peak corresponding to the (211) plane of the ferrite at the measurement position.

Note that substantially the same X-ray diffractometer as those manufactured by Rigaku may be used as long as the conditions except for the diffractometer among the following measurement conditions are satisfied.

### (Measurement Conditions of X-Ray Diffraction)

X-ray diffractometer: Rigaku AutoMATE
X-ray target: CrKα.
Acceleration voltage: 40 kV
Acceleration current: 40 mA
Collimator diameter: φ150 μm
X-ray scanning range (scanning start angle to scanning end angle): 146° to 165°

Note that when the X-ray diffraction is measured, the measurement may be performed after the L-section of the shaft portion of the bolt is processed as described below,

Specifically, the L-section of the shaft portion of the bolt is first wet-polished with #400 to #1500 emery paper (silicon carbide water-resistant abrasive paper). Thereafter, the test piece is polished by a polishing cloth impregnated with a diamond suspension (a liquid obtained by dispersing diamond powder having a grain size of 1 to 6 μm in a diluent such as alcohol and/or pure water) to finish the test piece as a mirror surface. Thereafter, the workpiece modification layer on the surface layer of the test piece is removed by polishing with colloidal silica. Then, at the center of the shaft portion and in the region up to 500 μm from the surface of the connection portion (e.g., 5 points away from the surface by 100 μm, 200 μm, 300 μm, 400 μm, and 500 μm), the full width at half maximum of the X-ray diffraction peak corresponding to the (211) plane of the ferrite is measured.

Further, when a film such as electro zinc plating may be present on the surface layer of the shaft portion of the bolt, the surface layer of the ground iron part is used as the starting point of the measurement without using the surface layer of the film part as the starting point of the measurement. The starting point of the measurement is set such that the region other than the ground iron is not included in the X-ray irradiation region (circular region having the same diameter as the collimator diameter) at the starting point of the measurement. That is, the starting point of the measurement is set such that the X-ray irradiation region at the starting point of the measurement circumscribes the surface layer portion of the ground iron part.

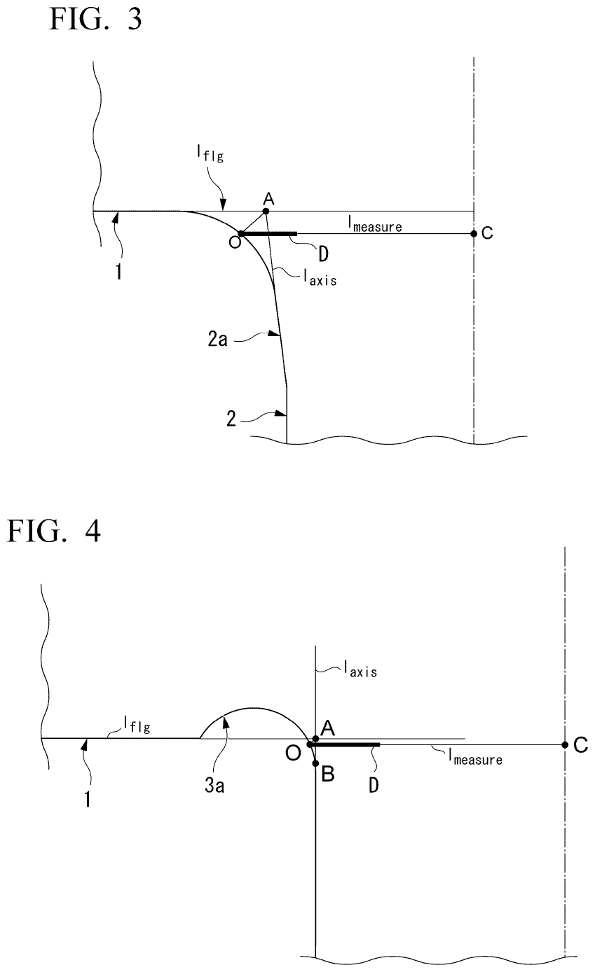

Further, as another example of the bolt, for instance, as illustrated in FIG. 3, there is a bolt in which an end portion on the head side of the shaft portion is tapered. In FIG. 3, reference numeral 1 denotes a contour line of a bearing surface of a bolt in an L-section, reference numeral 2 denotes a contour line of a cylindrical portion in the L-section, and reference numeral 3 denotes a contour line of a surface of a connection portion between a bolt head portion and a shaft portion. Furthermore, in this example, there is a tapered contour line 2a provided at the shaft portion between the contour lines 2 and 3.

The contour line 1 of the lower surface of the bolt head portion and the tapered contour line 2a are directed in directions intersecting each other. In FIG. 3, the contour line 2a of the tapered portion of the shaft portion is inclined with respect to the contour line 2 of the shaft portion by the tapered shape and is not orthogonal to the contour line 1. In addition, since the connection portion between the lower surface of the bolt head portion and the surface of the shaft portion is a minute R surface, the contour line 3 of the surface of the connection portion is approximately represented by a concave curve so as to connect the contour lines 1 and 2a extending in the intersecting direction.

As such, the bolt may be tapered. In this case, as shown in FIG. 3, an extension line of the contour line 1 of the lower surface of the bolt head portion is defined as l_{flg}, an extension line of the contour line 2a of the tapered portion of the shaft portion is defined as lₐₓᵢₛ, and a point of intersection between the extension line Ing and the extension line lₐₓᵢₛ is defined as A. Next, a line segment is drawn from the intersection point A toward the contour line 3, and the point of intersection between the line segment and the contour line 3 is defined as O. The line segment drawn from the intersection point A toward the contour line 3 is such a line segment that the angle formed with the extension line l_{flg} is 45°. Next, an extension line lₘₑₐₛᵤᵣₑ parallel to the extension line l_{flg} extends from the intersection point O toward the central axis 4 of the shaft portion. A point of intersection between the extension line lₘₑₐₛᵤᵣₑ and the central axis 4 is defined as C. Then, the intersection point C is set as a position of measuring the full width at half maximum β_{C}. In addition, a region D from the intersection point O to a depth of 500 μm along the extension line lₘₑₐₛᵤᵣₑ is defined as a measurement region of the full width at half maximum β_{MAX}.

Further, as shown in FIG. 4, as still another example of the bolt, there is a bolt in which the lower surface of the bolt head portion is undercut at the connection portion between the shaft portion and the bolt head portion. In FIG. 4, reference numeral 1 denotes a contour line of a bearing surface of a bolt in an L-section, reference numeral 2 denotes a contour line of the surface of a cylindrical portion in the L-section, and reference numeral 3a denotes a contour line of a surface of a connection portion between the bolt head portion and the shaft portion. The contour line 3a is a contour line with an undercut shape. Point B, which is a connection point between the contour line 2 of the shaft portion and the contour line 3a with an undercut shape, is positioned lower than the lower surface of the bolt head portion in the drawing. In addition, the contour line 1 of the lower surface of the bolt head portion and the contour line 2a of the shaft portion are directed in directions orthogonal to each other. The contour line 3a of the surface of the connection portion is approximately represented by a concave curve so as to connect the contour lines 1 and 2a extending in the intersecting direction while reflecting the shape of the undercut.

As such, the bolt may be undercut. In this case, as shown in FIG. 4, an extension line of the contour line 1 of the lower surface of the bolt head portion is defined as l_{flg}, an extension line of the contour line 2 of the shaft portion is defined as lₐₓᵢₛ, and a point of intersection between the extension line Ing and the extension line lₐₓᵢₛ is defined as A. Next, a line segment is drawn from the intersection point A toward the contour line 3a, and the point of intersection between the line segment and the contour line 3a is defined as O. The line segment drawn from the intersection point A toward the contour line 3a is such a line segment that the angle formed with the extension line Ins is 45°. Next, an extension line lₘₑₐₛᵤᵣₑ parallel to the extension line l_{flg} extends from the intersection point O toward the central axis 4 of the shaft portion. A point of intersection between the extension line lₘₑₐₛᵤᵣₑ and the central axis 4 is defined as C. Then, the intersection point C is set as a position of measuring the full width at half maximum β_{C}. In addition, a region D from the intersection point O to a depth of 500 μm along the extension line lₘₑₐₛᵤᵣₑ is defined as a measurement region of the full width at half maximum β_{MAX}.

### <<Tensile Strength>>

The tensile strength of the bolt according to the present embodiment is in the range of 800 to 1700 MPa. The bolt according to the present embodiment has exceptional hydrogen embrittlement resistance while the bolt has a tensile strength of 800 MPa or more. In addition, when the tensile strength is 1700 MPa or less, the bolt is exceptional in manufacture suitability.

As used herein, the term “tensile strength of the steel of the bolt” means a value measured in accordance with the test method described in JIS B 1051:2014.

Next, the method for producing a bolt according to the present embodiment will be described. The bolt of the present embodiment is produced by including a step of manufacturing a wire rod and a steel wire, and a step of manufacturing a bolt from the obtained steel wire.

### <Production of Wire Rod and Steel Wire>

A billet having the same chemical composition as the bolt according to the embodiment of the present invention is heated and hot-rolled at a finish rolling temperature of higher than 900° C. After the hot rolling, the temperature section from the winding end temperature to 500° C. is cooled at an average cooling rate of 10° C./sec or more (time arithmetical mean of cooling rates in the temperature section from the winding end temperature to 500° C.). Next, isothermal holding (isothermal transformation treatment) is performed to obtain a wire rod.

Specifically, immediately after completion of the winding after the hot rolling, the wire rod is immersed in a molten salt bath at 350 to 500° C. and is held at a constant temperature, From the viewpoint of sufficient temperature holding and productivity of the wire rod, the immersion time in the molten salt bath is set to 5 to 150 seconds. Note that the cooling after holding in the molten salt bath for a predetermined time may be water-cooling or air-cooling. Note that the same effect can be obtained by using equipment such as a lead bath or a fluidized bed as the immersion bath instead of the molten salt bath.

Thereafter, the wire is drawn to produce a steel wire. At this time, the wire is drawn in a single pass or a plurality of passes, and the total reduction of area is set to 15 to 65%.

The total reduction of area is 15% or more regardless of whether the wire is drawn in a single pass or a plurality of passes. When the total reduction of area is too low, hydrogen embrittlement resistance may be deteriorated. In addition, sufficient tensile strength may not be obtained.

Regardless of whether the wire is drawn in a single pass or a plurality of passes, the total reduction of area may be too high. In this case, workpiece cracking is likely to occur when a bolt is manufactured from a steel wire (by cold forging), and therefore the total reduction of area is set to 65% or less.

The diameter of the steel wire to be manufactured is not particularly limited as long as an appropriate diameter is selected according to the dimensions of the bolt according to the embodiment of the present invention, but may be, for example, 10.0 mm or less. Similarly, the shaft portion diameter of the bolt may be 10.0 mm or less.

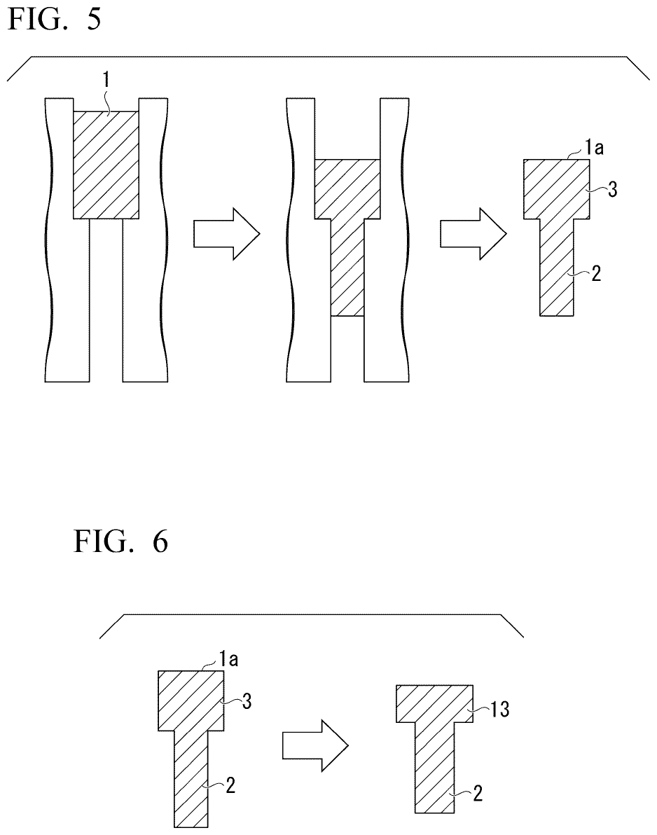

Next, the obtained steel wire is processed into a bolt shape by cold working (cold forging). The cold forging step includes a shearing step, a forward extrusion step, a bolt head preforming step, and a bolt head finishing step. Each step will be described with reference to FIGS. 5 to 7.

The bolt of the present embodiment is not limited to a bolt manufactured by the following manufacturing method. Even a bolt manufactured by a manufacturing method other than the following manufacturing method is included in the bolt of the present invention as long as the chemical composition, the metallographic structure, and the ratio of the full width at half maximum of the X-ray diffraction peak (ratio β_{MAX}/β_{C}) satisfy the ranges of the present invention.

In the shearing step, the obtained steel wire is cut and processed into a blank material having a required length.

In the forward extrusion step, as shown in FIG. 5, the blank material 1 is subjected to forward extrusion to draw part of the blank material 1 as an extruded material 1a. The drawn portion 2 (front extruded portion) of the extruded material 1a includes a portion corresponding to the lower part of the neck when finished into the shape of a flanged hexagonal bolt. Thereafter, the bolt head is formed through a bolt head preforming step and the bolt head finishing step (step 1).

The area reduction ratio R in the forward extrusion step may be, for example, 0.10 or more. When the cross-sectional area of the large-diameter portion 3 of the extruded material 1a is A₀ and the cross-sectional area of the drawn portion 2 of the extruded material 1a is A₁, the area reduction ratio R is defined as (A₀−A₁)/A₀. The strain distribution of the bolt is adjusted by the forward extrusion step, and the ratio (ratio β_{MAX}/β_{C}) of the full width at half maximum of the X-ray diffraction peak at the connection portion between the bolt head portion and the shaft portion can be set to 1.50 or less.

In the bolt head preforming step, as shown in FIG. 6, the large-diameter portion 3 (portion not subjected to the forward extrusion step) of the extruded material 1a subjected to the forward extrusion step is set up to form the preformed material 1b having the large-diameter portion 13 subjected to the upsetting process. In the preformed material 1b, the outer diameter of the large-diameter portion 13 is enlarged and the height of the large-diameter portion 13 is reduced with respect to the large-diameter portion 3 of the extruded material 1a (step 2).

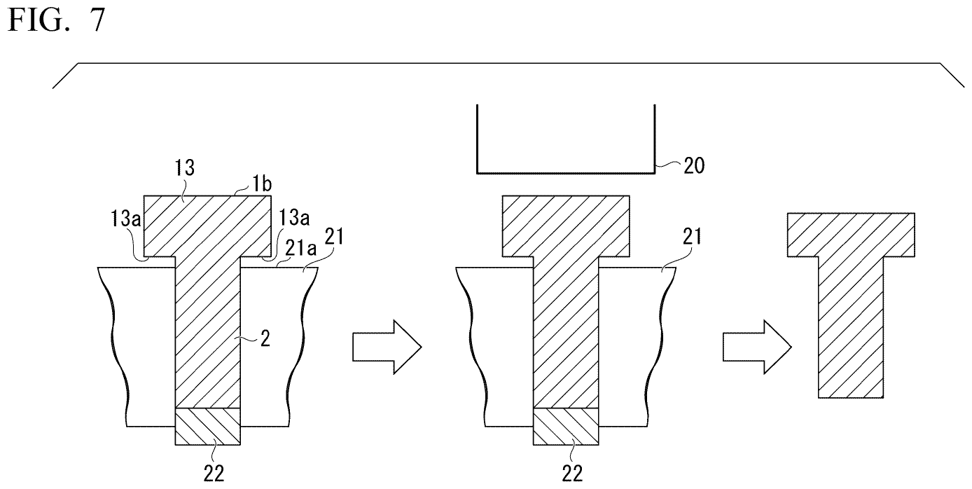

In the bolt head finishing step, as illustrated in FIG. 7, the preformed material 1b after the bolt head preforming step is inserted into the finishing forging die cavity 21 and set up by the punch 20, thereby processing into a final bolt shape. At this time, the knockout 22 is disposed under the preformed material 1b to position the preformed material 1b. When the preformed material 1b is inserted into the finishing forging die cavity 21, the lower end 13a of the large-diameter portion 13 (the upset portion) of the preformed material 1b and the upper end 21a of the finishing forging die cavity 21 are disposed so as not to come into contact with each other (step 3). Note that the punch 20 may be formed with an appropriate die cavity according to the shape of the head of the bolt to be formed. For example, in the case of forming a hexagon bolt with a flange, a punch having a hexagonal die cavity is used.

A distance between the lower end 13a of the large-diameter portion 13 (upset portion) and the upper end 21a of the finishing forging die cavity 21 is desirably (ΔL) mm or more and (ΔL+r) mm or less. Here, ΔL can be calculated by the following formula.

ΔL=L2×[(S2/S1)−1]

In the above formula, S1 is the cross-sectional area of the shaft portion of the preformed material 1b, S2 is the cross-sectional area of the shaft portion after the bolt head finishing process, L2 is the length of the shaft portion after the bolt head finishing step, and r is the radius of the shaft portion after the bolt head finishing step.

When the distance between the lower end 13a and the upper end 21a is less than (ΔL) mm, the ratio β_{MAX}/β_{C} of the full width at half maximum of the X-ray diffraction peak may become more than 1.50.

In the case of exceeding (ΔL+r) mm, buckling may occur in the bolt head finishing step. Thus, the distance between the lower end 13a and the upper end 21a is preferably (ΔL) mm or more and (ΔL+r) mm or less.

As such, the bolt head preforming step and the bolt head finishing step are designed. This can make 1.50 or less the ratio (ratio β_{MAX}/β_{C}) of the full width at half maximum of the X-ray diffraction peak at the connection portion between the bolt head portion and the shaft portion.

After the cold forging step, a thread portion is formed on the shaft portion of the bolt by rolling.

The bolt according to the present embodiment has high strength even as it is. However, in order to improve other mechanical properties required as a bolt, such as yield strength, yield ratio, and ductility, the bolt may be finished into a bolt shape, held at 200 to 600° C. for 10 to 300 minutes, and then cooled. Note that this heat treatment does not correspond to heat treatment for the tempered process.

In addition, film-coating treatment such as electro zinc plating may be performed for rust prevention. In addition, when hydrogen enters the bolt by the antirust coating treatment described above, the bolt may be held at 150 to 250° C. for 60 to 480 minutes and then cooled as heat treatment for releasing hydrogen to the outside of the bolt. Note that this heat treatment does not correspond to heat treatment for the tempered process.

As such, in the present embodiment, the steel wire having the chemical composition according to the present invention is cold forged through the shearing step, the forward extrusion step, the bolt head preforming step, and the bolt head finishing step as described above, and formed into a bolt shape. This can make 1.50 or less the ratio (ratio β_{MAX}/β_{C}) of the full width at half maximum of the X-ray diffraction peak at the connection portion between the bolt head portion and the shaft portion. It is thus possible to prevent delayed fracture starting from a connection portion as caused by hydrogen embrittlement,

### EXAMPLES

### <To Produce Bolt>

First, each steel wire was produced by the following procedure by using each billet having a chemical composition shown in Tables 1A to 2B. In the chemical composition of each steel type in Tables 1A to 2B, the balance other than the elements shown in Tables 1A to 2B is Fe and impurities. Note that it can be considered that the chemical composition of the steel wire is the same as the chemical composition of the billet. This 5 is because any of hot rolling, isothermal transformation treatment, water cooling, air cooling, and wire drawing included in the following procedure does not affect the chemical composition of the steel wire.

TABLE 1A

| | Chemical composition (unit: mass %; balance: Fe and impurities) | | | | | | | | | |
|---|---|---|---|---|---|---|---|---|---|---|
| No. | C | Si | Mn | P | S | Al | Ti | B | N | O |
| 1 | 0.18 | 0.25 | 1.26 | 0.010 | 0.012 | 0.031 | 0.019 | 0.0014 | 0.0036 | 0.0016 |
| 2 | 0.80 | 0.12 | 1.15 | 0.009 | 0.009 | 0.039 | 0.014 | 0.0013 | 0.0030 | 0.0020 |
| 3 | 0.63 | 0.01 | 1.07 | 0.010 | 0.012 | 0.028 | 0.016 | 0.0013 | 0.0034 | 0.0019 |
| 4 | 0.22 | 1.42 | 0.88 | 0.011 | 0.008 | 0.038 | 0.012 | 0.0012 | 0.0039 | 0.0019 |
| 5 | 0.69 | 0.30 | 0.54 | 0.011 | 0.008 | 0.029 | 0.017 | 0.0018 | 0.0038 | 0.0019 |
| 6 | 0.27 | 0.08 | 1.91 | 0.008 | 0.008 | 0.038 | 0.016 | 0.0020 | 0.0026 | 0.0027 |
| 7 | 0.46 | 0.19 | 0.97 | 0.028 | 0.009 | 0.032 | 0.015 | 0.0011 | 0.0019 | 0.0021 |
| 8 | 0.60 | 0.09 | 0.93 | 0.009 | 0.028 | 0.028 | 0.014 | 0.0020 | 0.0026 | 0.0018 |
| 9 | 0.51 | 0.17 | 1.03 | 0.009 | 0.011 | 0.008 | 0.018 | 0.0014 | 0.0045 | 0.0020 |
| 10 | 0.56 | 0.14 | 0.86 | 0.008 | 0.008 | 0.076 | 0.017 | 0.0014 | 0.0038 | 0.0023 |
| 11 | 0.47 | 0.09 | 0.86 | 0.010 | 0.001 | 0.044 | 0.005 | 0.0018 | 0.0015 | 0.0018 |
| 12 | 0.38 | 0.08 | 1.12 | 0.009 | 0.010 | 0.035 | 0.095 | 0.0016 | 0.0027 | 0.0010 |
| 13 | 0.52 | 0.07 | 0.96 | 0.005 | 0.009 | 0.041 | 0.018 | 0.0003 | 0.0024 | 0.0013 |
| 14 | 0.58 | 0.15 | 0.97 | 0.008 | 0.011 | 0.033 | 0.018 | 0.0048 | 0.0024 | 0.0017 |
| 15 | 0.63 | 0.16 | 0.81 | 0.011 | 0.010 | 0.032 | 0.017 | 0.0016 | 0.0143 | 0.0023 |
| 16 | 0.48 | 0.07 | 0.95 | 0.011 | 0.009 | 0.028 | 0.018 | 0.0010 | 0.0037 | 0.0095 |
| 17 | 0.49 | 0.07 | 0.51 | 0.010 | 0.007 | 0.024 | 0.020 | 0.0015 | 0.0053 | 0.0025 |
| 18 | 0.42 | 0.05 | 0.57 | 0.004 | 0.008 | 0.039 | 0.022 | 0.0015 | 0.0034 | 0.0015 |
| 19 | 0.61 | 0.09 | 0.90 | 0.008 | 0.006 | 0.038 | 0.016 | 0.0013 | 0.0024 | 0.0028 |
| 20 | 0.38 | 0.13 | 0.86 | 0.012 | 0.002 | 0.039 | 0.018 | 0.0008 | 0.0022 | 0.0010 |
| 21 | 0.40 | 0.10 | 0.82 | 0.008 | 0.007 | 0.041 | 0.017 | 0.0010 | 0.0025 | 0.0013 |
| 22 | 0.59 | 0.11 | 0.71 | 0.012 | 0.006 | 0.028 | 0.015 | 0.0015 | 0.0029 | 0.0025 |
| 23 | 0.46 | 0.16 | 1.06 | 0.008 | 0.005 | 0.029 | 0.019 | 0.0020 | 0.0030 | 0.0017 |
| 24 | 0.68 | 0.09 | 0.94 | 0.009 | 0.008 | 0.036 | 0.013 | 0.0015 | 0.0046 | 0.0017 |
| 25 | 0.39 | 0.12 | 0.85 | 0.009 | 0.006 | 0.040 | 0.017 | 0.0012 | 0.0024 | 0.0011 |
| 26 | 0.73 | 0.23 | 0.91 | 0.009 | 0.010 | 0.039 | 0.016 | 0.0013 | 0.0030 | 0.0024 |
| 27 | 0.49 | 0.07 | 0.79 | 0.010 | 0.011 | 0.038 | 0.020 | 0.0014 | 0.0029 | 0.0014 |
| 28 | 0.70 | 0.13 | 0.77 | 0.010 | 0.009 | 0.024 | 0.012 | 0.0018 | 0.0027 | 0.0017 |
| 29 | 0.58 | 0.10 | 0.65 | 0.010 | 0.007 | 0.042 | 0.017 | 0.0018 | 0.0037 | 0.0018 |
| 30 | 0.65 | 0.25 | 1.04 | 0.009 | 0.003 | 0.030 | 0.023 | 0.0010 | 0.0033 | 0.0023 |
| 31 | 0.68 | 0.19 | 0.83 | 0.009 | 0.006 | 0.032 | 0.014 | 0.0014 | 0.0037 | 0.0028 |
| 32 | 0.65 | 0.16 | 1.01 | 0.010 | 0.005 | 0.046 | 0.017 | 0.0010 | 0.0029 | 0.0025 |
| 33 | 0.51 | 0.15 | 0.82 | 0.008 | 0.003 | 0.038 | 0.015 | 0.0017 | 0.0045 | 0.0017 |
| 34 | 0.53 | 0.26 | 0.88 | 0.011 | 0.000 | 0.034 | 0.015 | 0.0020 | 0.0031 | 0.0021 |
| 35 | 0.71 | 0.15 | 1.05 | 0.010 | 0.007 | 0.029 | 0.017 | 0.0015 | 0.0037 | 0.0017 |
| 36 | 0.59 | 0.15 | 0.97 | 0.011 | 0.009 | 0.038 | 0.020 | 0.0015 | 0.0015 | 0.0021 |
| 37 | 0.69 | 0.15 | 0.72 | 0.010 | 0.009 | 0.033 | 0.016 | 0.0015 | 0.0039 | 0.0019 |
| 38 | 0.44 | 0.20 | 0.70 | 0.010 | 0.012 | 0.029 | 0.015 | 0.0016 | 0.0041 | 0.0032 |
| 39 | 0.59 | 0.20 | 0.71 | 0.013 | 0.003 | 0.025 | 0.013 | 0.0017 | 0.0029 | 0.0013 |
| 40 | 0.35 | 0.33 | 1.01 | 0.011 | 0.012 | 0.022 | 0.024 | 0.0011 | 0.0024 | 0.0019 |
| 41 | 0.67 | 0.18 | 0.97 | 0.012 | 0.011 | 0.028 | 0.011 | 0.0016 | 0.0014 | 0.0023 |

TABLE 1B

| | Chemical composition (unit: mass %; balance: Fe and impurities) | | | | | | | | | |
|---|---|---|---|---|---|---|---|---|---|---|
| No. | C | Si | Mn | P | S | AI | Ti | B | N | O |
| 42 | 0.15 | 0.12 | 1.26 | 0.008 | 0.008 | 0.041 | 0.015 | 0.0017 | 0.0030 | 0.0013 |
| 43 | 0.84 | 0.27 | 0.91 | 0.011 | 0.009 | 0.033 | 0.015 | 0.0007 | 0.0044 | 0.0024 |
| 44 | 0.66 | 1.53 | 1.29 | 0.011 | 0.009 | 0.034 | 0.020 | 0.0012 | 0.0031 | 0.0018 |
| 45 | 0.70 | 0.11 | 2.02 | 0.012 | 0.006 | 0.038 | 0.012 | 0.0013 | 0.0008 | 0.0026 |
| 46 | 0.60 | 0.17 | 0.98 | 0.032 | 0.007 | 0.038 | 0.014 | 0.0014 | 0.0035 | 0.0027 |
| 47 | 0.56 | 0.20 | 0.77 | 0.009 | 0.033 | 0.042 | 0.018 | 0.0016 | 0.0031 | 0.0020 |
| 48 | 0.71 | 0.08 | 0.93 | 0.010 | 0.004 | 0.018 | 0.002 | 0.0013 | 0.0046 | 0.0033 |
| 49 | 0.46 | 0.30 | 1.02 | 0.009 | 0.011 | 0.033 | 0.103 | 0.0013 | 0.0026 | 0.0021 |
| 50 | 0.65 | 0.11 | 0.68 | 0.011 | 0.011 | 0.036 | 0.023 | 0.0002 | 0.0030 | 0.0019 |
| 51 | 0.65 | 0.18 | 1.01 | 0.009 | 0.013 | 0.036 | 0.013 | 0.0055 | 0.0030 | 0.0019 |
| 52 | 0.46 | 0.41 | 0.94 | 0.012 | 0.010 | 0.034 | 0.014 | 0.0015 | 0.0156 | 0.0024 |
| 53 | 0.60 | 0.16 | 1.04 | 0.012 | 0.009 | 0.023 | 0.018 | 0.0019 | 0.0020 | 0.0105 |
| 54 | 0.58 | 0.17 | 1.24 | 0.012 | 0.010 | 0.024 | 0.014 | 0.0012 | 0.0021 | 0.0021 |
| 55 | 0.62 | 0.15 | 1.07 | 0.009 | 0.010 | 0.032 | 0.016 | 0.0013 | 0.0021 | 0.0027 |
| 56 | 0.60 | 0.37 | 1.20 | 0.011 | 0.005 | 0.032 | 0.018 | 0.0013 | 0.0037 | 0.0019 |
| 57 | 0.69 | 0.14 | 0.95 | 0.014 | 0.006 | 0.030 | 0.015 | 0.0012 | 0.0040 | 0.0018 |
| 58 | 0.70 | 0.13 | 0.96 | 0.013 | 0.010 | 0.035 | 0.017 | 0.0015 | 0.0035 | 0.0019 |
| 59 | 0.68 | 0.15 | 0.99 | 0.010 | 0.006 | 0.032 | 0.015 | 0.0014 | 0.0033 | 0.0030 |
| 60 | 0.59 | 0.26 | 1.05 | 0.008 | 0.007 | 0.041 | 0.017 | 0.0015 | 0.0030 | 0.0020 |
| 61 | 0.71 | 0.21 | 1.00 | 0.010 | 0.008 | 0.018 | 0.017 | 0.0014 | 0.0032 | 0.0013 |
| 62 | 0.67 | 0.23 | 0.91 | 0.011 | 0.009 | 0.035 | 0.018 | 0.0018 | 0.0037 | 0.0015 |
| 63 | 0.63 | 0.22 | 0.89 | 0.010 | 0.010 | 0.027 | 0.014 | 0.0012 | 0.0023 | 0.0023 |
| 64 | 0.69 | 0.20 | 0.87 | 0.010 | 0.008 | 0.036 | 0.014 | 0.0019 | 0.0028 | 0.0019 |
| 65 | 0.46 | 0.33 | 0.98 | 0.012 | 0.006 | 0.027 | 0.020 | 0.0014 | 0.0040 | 0.0016 |
| 66 | 0.65 | 0.15 | 1.12 | 0.013 | 0.006 | 0.028 | 0.014 | 0.0018 | 0.0023 | 0.0025 |
| 67 | 0.56 | 0.11 | 1.11 | 0.009 | 0.004 | 0.035 | 0.017 | 0.0012 | 0.0030 | 0.0015 |
| 68 | 0.28 | 0.11 | 1.11 | 0.011 | 0.009 | 0.035 | 0.016 | 0.0010 | 0.0026 | 0.0021 |

*Underlined part means out of the range in the present invention.

TABLE 2A

| | Chemical composition (unit: mass %; balance: Fe and impurities) | | | | | | | | | | |
|---|---|---|---|---|---|---|---|---|---|---|---|
| | Group A | | | | | Group B | | Group C | | | |
| No. | Cr | Mo | Nb | V | W | Cu | Ni | Ca | Mg | Ce | Sn |
| 1 | | | | | | | | | | | |
| 2 | | | | | | | | | | | |
| 3 | | | | | | | | | | | |
| 4 | | | | | | | | | | | |
| 5 | | | | | | | | | | | |
| 6 | | | | | | | | | | | |
| 7 | | | | | | | | | | | |
| 8 | | | | | | | | | | | |
| 9 | | | | | | | | | | | |
| 10 | | | | | | | | | | | |
| 11 | | | | | | | | | | | |
| 12 | | | | | | | | | | | |
| 13 | | | | | | | | | | | |
| 14 | | | | | | | | | | | |
| 15 | | | | | | | | | | | |
| 16 | | | | | | | | | | | |
| 17 | 1.44 | | | | | | | | | | |
| 18 | | 0.48 | | | | | | | | | |
| 19 | | | 0.049 | | | | | | | | |
| 20 | | | | 0.20 | | | | | | | |
| 21 | | | | | 0.18 | | | | | | |
| 22 | | | | | | 0.47 | 0.41 | | | | |
| 23 | | | | | | | | 0.0097 | | | |
| 24 | | | | | | | | | 0.0098 | | |
| 25 | | | | | | | | | | 0.019 | |
| 26 | | | | | | | | | | | 0.0350 |
| 27 | 0.07 | 0.04 | | | | | | | | | |
| 28 | 0.12 | | 0.010 | | | | | | | | |
| 29 | | 0.11 | | 0.06 | | | | | | | |
| 30 | | | | | | 0.02 | 0.01 | | | | |
| 31 | | | | | | | | 0.0011 | 0.0009 | | |
| 32 | | | | | | | | 0.0015 | | | 0.0005 |
| 33 | 0.11 | | | | | 0.01 | | | | | |
| 34 | | | 0.015 | | | 0.03 | 0.02 | | | | |
| 35 | | | | | | 0.02 | 0.02 | | 0.0014 | | |
| 36 | | | | | | 0.04 | 0.03 | | | | 0.0004 |
| 37 | | 0.06 | | 0.04 | | | | | | | 0.0006 |
| 38 | 0.20 | | | | | | | 0.0014 | | | |
| 39 | 0.13 | | | | | 0.02 | 0.01 | 0.0012 | | | |
| 40 | | | | | | | | | | | |
| 41 | | | | | | | | | | | |

TABLE 2B

| | Chemical composition (unit; mass %; balance: Fe and impurities) | | | | | | | | | | |
|---|---|---|---|---|---|---|---|---|---|---|---|
| | Group A | | | | | Group B | | Group C | | | |
| No. | Cr | Mo | Nb | V | W | Cu | Ni | Ca | Mg | Ce | Sn |

| | | | | | | | | | | |
|---|---|---|---|---|---|---|---|---|---|---|
| 42 | | | | | | | | | | |
| 43 | | | | | | | | | | |
| 44 | | | | | | | | | | |
| 45 | | | | | | | | | | |
| 46 | | | | | | | | | | |
| 47 | | | | | | | | | | |
| 48 | | | | | | | | | | |
| 49 | | | | | | | | | | |
| 50 | | | | | | | | | | |
| 51 | | | | | | | | | | |
| 52 | | | | | | | | | | |
| 53 | | | | | | | | | | |
| 54 | 1.53 | | | | | | | | | |
| 55 | | 0.52 | | | | | | | | |
| 56 | | | 0.054 | | | | | | | |
| 57 | | | | 0.26 | | | | | | |
| 58 | | | | | 0.35 | | | | | |
| 59 | | | | | | 0.55 | | | | |
| 60 | | | | | | | 0.0103 | | | |
| 61 | | | | | | | | 0.0105 | | |
| 62 | | | | | | | | | 0.060 | |
| 63 | | | | | | | | | | 0.0562 |
| 64 | | | | | | | | | | |
| 65 | | | | | | | | | | |
| 66 | | | | | | | | | | |
| 67 | | | | | | | | | | |
| 68 | | | | | | | | | | |

*Underlined part means out of the range in the present invention.

Each billet in standards 1 to 63 and 65 to 68 was subjected to hot rolling under the conditions shown in Table 2, and the temperature section from the winding end temperature to 500° C. was cooled at an average cooling rate of 10° C./sec or more to obtain a wire rod having a wire rod diameter shown in Table 2. Next, each steel wire was obtained by sequentially performing isothermal transformation treatment, water cooling, and wire drawing under the conditions shown in Tables 3A and 3B. Note that all the standards are standards drawn in a single pass.

In the standard 64, the billet was subjected to hot rolling under the conditions shown in Table 3B and air-cooling without performing isothermal transformation treatment. Thereafter, the wire was drawn under the conditions shown in Table 3B to obtain a steel wire,

Next, the steel wire of each standard was subjected to cold working (cold forging) under the conditions shown in Tables 3A and 3B to form the steel wire into the shape of a flanged hexagonal bolt having a nominal diameter of 8.0 mm or 4.0 mm (M8 or M4 hexagonal bolt with a flange as defined in JIS B1189: 2015).

“Heading 1” in Tables 3A and 3B was performed under the condition for cold working described below. Specifically, the shearing step, the forward extrusion step, the bolt head preforming step, and the bolt head finishing step were performed. In the shearing step, a steel wire was cut into a blank material. In the forward extrusion step, as shown in FIG. 5, the blank material 1 was subjected to forward extrusion to produce an extruded material 1a having the drawn portion 2 and the large-diameter portion 3. The area reduction ratio was 0.12. In the bolt head preforming step, as shown in FIG. 6, the large-diameter portion 3 of the extruded material 1a was set up to form the preformed material 1b having the large-diameter portion 13 subjected to the upsetting process. In the bolt head finishing step, as illustrated in FIG. 7, the preformed material 1b was inserted into the finishing forging die cavity 21 and set up by the punch 20 having a hexagonal die cavity, thereby processing into a final flanged hexagonal bolt shape. The lower end 13a of the large-diameter portion 13 of the preformed material 1b was disposed so as not to come into contact with the upper end 21a of the finishing forging die cavity 21 during processing. A distance between the lower end 13a of the large-diameter portion 13 (upset portion) and the upper end 21a of the finishing forging die cavity 21 was 0.45 mm. Note that in “Heading 1”, ΔL=0.30 mm. ΔL+r was greater than 0.45 mm.

“Heading 2” in Tables 3A and 3B was performed such that the lower end 13a of the large-diameter portion 13 of the preformed material 1b was disposed and brought into contact with the upper end 21a of the finishing forging die cavity 21 in the bolt head finishing step. A distance between the lower end 13a of the large-diameter portion 13 (upset portion) and the upper end 21a of the finishing forging die cavity 21 was 0 mm, which was less than ΔL. The other conditions were the same as in “Heading 1”.

In “Heading 3” in Tables 3A and 3B, cold working was performed in the same manner as in “Heading 1” except that the area reduction ratio in the forward extrusion step was 0.11, and the distance between the lower end 13a of the large-diameter portion 13 (upset portion) and the upper end 21a of the finishing forging die cavity 21 in the bolt head finishing step was 0.42 mm. Note that in “Heading 3”, ΔL=0.41 mm. ΔL+r was greater than 0.42 mm.

Note that it can be considered that the chemical composition of the steel of the bolt is the same as the chemical composition of the steel wire. This is because the cold working (cold forging) and the heat treatment described above do not affect the chemical composition of the steel of the bolt. That is, it can be considered that the chemical 5 composition of the steel of the bolt is the same as the chemical composition of the billet.

TABLE 3A

| | | Steel wire production conditions | | | | | | |
|---|---|---|---|---|---|---|---|---|
| | | | | Isothermal | | | | |
| | | | | transformation treatment | | Water | Wire | |
| | | Hot rolling | | | Molten salt | cooling | drawing | |
| | | | Finish | Molten salt | bath | Water | Total area | Non-tempered |
| | Wire rod | Heating | rolling | bath | immersion | cooling end | reduction | bolt production |
| | diameter | temperature | temperature | temperature | time | temperature | ratio | conditions |
| No. | (mm) | (° C.) | (° C.) | (° C.) | (s) | (° C.) | (%) | Heading |
| 1 | 10.0 | 1094 | 861 | 456 | 63 | 219 | 27.8 | Heading 1 |
| 2 | 10.0 | 1083 | 864 | 459 | 63 | 224 | 27.8 | Heading 1 |
| 3 | 10.0 | 1091 | 855 | 463 | 63 | 196 | 27.8 | Heading 1 |
| 4 | 10.0 | 1095 | 864 | 458 | 63 | 226 | 27.8 | Heading 1 |
| 5 | 10.0 | 1090 | 859 | 457 | 63 | 214 | 27.8 | Heading 1 |
| 6 | 10.0 | 1102 | 857 | 470 | 63 | 208 | 27.8 | Heading 1 |
| 7 | 10.0 | 1087 | 858 | 457 | 63 | 233 | 27.8 | Heading 1 |
| 8 | 10.0 | 1097 | 845 | 466 | 63 | 235 | 27.8 | Heading 1 |
| 9 | 10.0 | 1099 | 865 | 463 | 63 | 242 | 27.8 | Heading 1 |
| 10 | 10.0 | 1090 | 848 | 468 | 63 | 223 | 27.8 | Heading 1 |
| 11 | 10.0 | 1086 | 862 | 455 | 63 | 226 | 27.8 | Heading 1 |
| 12 | 10.0 | 1090 | 855 | 459 | 63 | 208 | 27.8 | Heading 1 |
| 13 | 10.0 | 1092 | 872 | 463 | 63 | 220 | 27.8 | Heading 1 |
| 14 | 10.0 | 1095 | 851 | 461 | 63 | 224 | 27.8 | Heading 1 |
| 15 | 10.0 | 1083 | 853 | 457 | 63 | 215 | 27.8 | Heading 1 |
| 16 | 10.0 | 1081 | 845 | 457 | 63 | 205 | 27.8 | Heading 1 |
| 17 | 10.0 | 1104 | 863 | 464 | 63 | 224 | 27.8 | Heading 1 |
| 18 | 10.0 | 1109 | 864 | 468 | 63 | 221 | 27.8 | Heading 1 |
| 19 | 10.0 | 1123 | 868 | 461 | 63 | 226 | 27.8 | Heading 1 |
| 20 | 10.0 | 1106 | 866 | 460 | 63 | 220 | 27.8 | Heading 1 |
| 21 | 10.0 | 1100 | 869 | 462 | 63 | 210 | 27.8 | Heading 1 |
| 22 | 10.0 | 1098 | 863 | 461 | 63 | 230 | 27.8 | Heading 1 |
| 23 | 10.0 | 1087 | 858 | 460 | 63 | 218 | 27.8 | Heading 1 |
| 24 | 10.0 | 1092 | 859 | 452 | 63 | 217 | 27.8 | Heading 1 |
| 25 | 10.0 | 1099 | 870 | 461 | 63 | 208 | 27.8 | Heading 1 |
| 26 | 10.0 | 1086 | 870 | 463 | 63 | 226 | 27.8 | Heading 1 |
| 27 | 10.0 | 1101 | 852 | 465 | 63 | 214 | 27.8 | Heading 1 |
| 28 | 10.0 | 1098 | 864 | 458 | 63 | 216 | 27.8 | Heading 1 |
| 29 | 10.0 | 1079 | 867 | 453 | 63 | 227 | 27.8 | Heading 1 |
| 30 | 10.0 | 1114 | 866 | 457 | 63 | 206 | 27.8 | Heading 1 |
| 31 | 10.0 | 1088 | 858 | 460 | 63 | 226 | 27.8 | Heading 1 |
| 32 | 10.0 | 1108 | 863 | 460 | 63 | 204 | 27.8 | Heading 1 |
| 33 | 10.0 | 1089 | 872 | 459 | 63 | 213 | 27.8 | Heading 1 |
| 34 | 10.0 | 1113 | 851 | 454 | 63 | 221 | 27.8 | Heading 1 |
| 35 | 10.0 | 1089 | 850 | 460 | 63 | 193 | 27.8 | Heading 1 |
| 36 | 10.0 | 1102 | 835 | 468 | 63 | 223 | 27.8 | Heading 1 |
| 37 | 10.0 | 1096 | 865 | 452 | 63 | 239 | 27.8 | Heading 1 |
| 38 | 10.0 | 1089 | 855 | 452 | 63 | 224 | 27.8 | Heading 1 |
| 39 | 10.0 | 1095 | 853 | 467 | 63 | 208 | 27.8 | Heading 1 |
| 40 | 5.0 | 1085 | 880 | 459 | 63 | 225 | 29.4 | Heading 3 |
| 41 | 5.0 | 1097 | 866 | 453 | 63 | 242 | 29.4 | Heading 3 |

TABLE 3B

| | | Steel wire production conditions | | | | | | |
|---|---|---|---|---|---|---|---|---|
| | | | | Isothermal | | | | |
| | | | | transformation treatment | | Water | Wire | |
| | | Hot rolling | | | Molten salt | cooling | drawing | |
| | | | Finish | Molten salt | bath | Water | Total area | Non-tempered |
| | Wire rod | Heating | rolling | bath | immersion | cooling end | reduction | bolt production |
| | diameter | temperature | temperature | temperature | time | temperature | ratio | conditions |
| No. | (mm) | (° C.) | (° C.) | (° C.) | (s) | (° C.) | (%) | Heading |
| 42 | 10.0 | 1097 | 871 | 460 | 63 | 215 | 27.8 | Heading 1 |
| 43 | 10.0 | 1094 | 860 | 456 | 63 | 210 | 27.8 | Heading 1 |
| 44 | 10.0 | 1086 | 852 | 454 | 63 | 222 | 27.8 | Heading 1 |
| 45 | 10.0 | 1097 | 865 | 460 | 63 | 254 | 27.8 | Heading 1 |
| 46 | 10.0 | 1086 | 865 | 455 | 63 | 207 | 27.8 | Heading 1 |
| 47 | 10.0 | 1083 | 853 | 459 | 63 | 214 | 27.8 | Heading 1 |
| 48 | 10.0 | 1098 | 848 | 459 | 63 | 216 | 27.8 | Heading 1 |
| 49 | 10.0 | 1093 | 857 | 458 | 63 | 239 | 27.8 | Heading 1 |
| 50 | 10.0 | 1087 | 870 | 471 | 63 | 204 | 27.8 | Heading 1 |
| 51 | 10.0 | 1096 | 854 | 451 | 63 | 251 | 27.8 | Heading 1 |
| 52 | 10.0 | 1088 | 860 | 464 | 63 | 238 | 27.8 | Heading 1 |
| 53 | 10.0 | 1098 | 850 | 461 | 63 | 212 | 27.8 | Heading 1 |
| 54 | 10.0 | 1100 | 856 | 464 | 63 | 184 | 27.8 | Heading 1 |
| 55 | 10.0 | 1088 | 851 | 454 | 63 | 228 | 27.8 | Heading 1 |
| 56 | 10.0 | 1081 | 844 | 458 | 63 | 221 | 27.8 | Heading 1 |
| 57 | 10.0 | 1067 | 880 | 465 | 63 | 244 | 27.8 | Heading 1 |
| 58 | 10.0 | 1071 | 875 | 468 | 63 | 232 | 27.8 | Heading 1 |
| 59 | 10.0 | 1085 | 862 | 458 | 63 | 229 | 27.8 | Heading 1 |
| 60 | 10.0 | 1082 | 837 | 462 | 63 | 219 | 27.8 | Heading 1 |
| 61 | 10.0 | 1089 | 851 | 467 | 63 | 210 | 27.8 | Heading 1 |
| 62 | 10.0 | 1090 | 864 | 466 | 63 | 209 | 27.8 | Heading 1 |
| 63 | 10.0 | 1087 | 855 | 455 | 63 | 248 | 27.8 | Heading 1 |
| 64 | 10.0 | 1088 | 860 | (Air- | — | — | 27.8 | Heading 1 |
| | | | | cooling) | | | | |
| 65 | 10.0 | 1099 | 864 | 463 | 4 | 255 | 27.8 | Heading 1 |
| 66 | 10.0 | 1099 | 861 | 458 | 63 | 236 | 27.8 | Heading 2 |
| 67 | 10.0 | 1086 | 849 | 467 | 63 | 209 | 27.8 | Heading 2 |
| 68 | 8.7 | 1101 | 878 | 469 | 63 | 224 | 8.5 | Heading 1 |

*Underlined part indicates out of the range for preferred production conditions

### <To Measure Bolt>

For the bolts of each standard, the area fraction of the hard structure (bainite structure) at the D/4 position was measured, the balance other than the hard structure (bainite structure) at the D/4 position were observed, the full width at half maximum of the X-ray diffraction peak was measured, and the tensile strength was measured by the method described above, respectively.

### <To Measure Full Width at Half Maximum of X-Ray Diffraction Peak>

For the bolts of each standard, the ratio β_{MAX}/β_{C} while β_{MAX} is the maximum value of the full width at half maximum of the X-ray diffraction peak corresponding to the (211) plane of the ferrite was measured by the measurement method described above. The full width at half maximum was calculated using software attached to an X-ray diffractometer (Rigaku AutoMATE).

### <To Measure Tensile Strength of Bolt>

For the bolts of each standard, the tensile strength was measured by the measurement method described above. The crosshead displacement speed during the tensile test was 3.0 mm/min.

### <To Evaluate Hydrogen Embrittlement Resistance of Bolt>

The hydrogen embrittlement resistance of each obtained bolt was measured by the following method. First, 0.5 ppm of diffusible hydrogen was included in the bolt by charging the bolt with electrolytic hydrogen.

The electrolytic hydrogen charging method was in accordance with ISO16573. The samples were then each subjected to Cd plating in order to prevent the release of hydrogen from the machine parts into the atmosphere during the test. Next, in the atmosphere, a load of 90% of the maximum tensile load of the bolt was applied to the bolt, and the bolt was held in this state for 100 hours or more.

As a result, when no breakage occurred after a lapse of 100 hours, the hydrogen embrittlement resistance was determined to be good, and when breakage occurred after a lapse of 100 hours, the hydrogen embrittlement resistance was determined to be poor.

The results are shown in Tables 4A and 4B.

TABLE 4A

| | Metallographic structure of non- | | | | | | | |
|---|---|---|---|---|---|---|---|---|
| | tempered bolt | | | | | | | |
| | | Hard | | | Characteristics | | | |
| | Carbon | structure | | | Tensile | | Hydrogen | |
| | content | area fraction | Rest | β_{MAX}/β_{C} | strength | Cold | embrittlement | |
| No. | (%) | (%) | structure | (—) | (MPa) | workability | resistance | Remarks |
| 1 | 0.18 | 96 | F | 1.19 | 805 | Good | Good | Example of the |
| | | | | | | | | present invention |
| 2 | 0.80 | 100 | — | 1.27 | 1580 | Good | Good | Example of the |
| | | | | | | | | present invention |
| 3 | 0.63 | 100 | — | 1.20 | 1290 | Good | Good | Example of the |
| | | | | | | | | present invention |
| 4 | 0.22 | 95 | F | 1.13 | 900 | Good | Good | Example of the |
| | | | | | | | | present invention |
| 5 | 0.69 | 98 | F | 1.24 | 1279 | Good | Good | Example of the |
| | | | | | | | | present invention |
| 6 | 0.27 | 98 | F | 1.16 | 1046 | Good | Good | Example of the |
| | | | | | | | | present invention |
| 7 | 0.46 | 100 | — | 1.23 | 1075 | Good | Good | Example of the |
| | | | | | | | | present invention |
| 8 | 0.60 | 100 | — | 1.30 | 1224 | Good | Good | Example of the |
| | | | | | | | | present invention |
| 9 | 0.51 | 100 | — | 1.32 | 1145 | Good | Good | Example of the |
| | | | | | | | | present invention |
| 10 | 0.56 | 96 | F | 1.24 | 1162 | Good | Good | Example of the |
| | | | | | | | | present invention |
| 11 | 0.47 | 98 | F | 1.20 | 1049 | Good | Good | Example of the |
| | | | | | | | | present invention |
| 12 | 0.38 | 100 | — | 1.18 | 1015 | Good | Good | Example of the |
| | | | | | | | | present invention |
| 13 | 0.52 | 100 | — | 1.22 | 1130 | Good | Good | Example of the |
| | | | | | | | | present invention |
| 14 | 0.58 | 98 | F | 1.22 | 1218 | Good | Good | Example of the |
| | | | | | | | | present invention |
| 15 | 0.63 | 99 | F | 1.25 | 1238 | Good | Good | Example of the |
| | | | | | | | | present invention |
| 16 | 0.48 | 96 | F | 1.16 | 1073 | Good | Good | Example of the |
| | | | | | | | | present invention |
| 17 | 0.49 | 98 | F | 1.29 | 1342 | Good | Good | Example of the |
| | | | | | | | | present invention |
| 18 | 0.42 | 100 | — | 1.18 | 1095 | Good | Good | Example of the |
| | | | | | | | | present invention |
| 19 | 0.61 | 99 | F | 1.23 | 1232 | Good | Good | Example of the |
| | | | | | | | | present invention |
| 20 | 0.38 | 96 | F | 1.18 | 1033 | Good | Good | Example of the |
| | | | | | | | | present invention |
| 21 | 0.40 | 97 | F | 1.20 | 1035 | Good | Good | Example of the |
| | | | | | | | | present invention |
| 22 | 0.59 | 99 | F | 1.19 | 1163 | Good | Good | Example of the |
| | | | | | | | | present invention |
| 23 | 0.46 | 100 | — | 1.26 | 1094 | Good | Good | Example of the |
| | | | | | | | | present invention |
| 24 | 0.68 | 100 | — | 1.20 | 1326 | Good | Good | Example of the |
| | | | | | | | | present invention |
| 25 | 0.39 | 97 | F | 1.19 | 1028 | Good | Good | Example of the |
| | | | | | | | | present invention |
| 26 | 0.73 | 95 | F | 1.23 | 1402 | Good | Good | Example of the |
| | | | | | | | | present invention |
| 27 | 0.49 | 100 | — | 1.17 | 1143 | Good | Good | Example of the |
| | | | | | | | | present invention |
| 28 | 0.70 | 96 | F | 1.17 | 1342 | Good | Good | Example of the |
| | | | | | | | | present invention |
| 29 | 0.58 | 100 | — | 1.30 | 1236 | Good | Good | Example of the |
| | | | | | | | | present invention |
| 30 | 0.65 | 100 | — | 1.14 | 1335 | Good | Good | Example of the |
| | | | | | | | | present invention |
| 31 | 0.68 | 97 | F | 1.23 | 1319 | Good | Good | Example of the |
| | | | | | | | | present invention |
| 32 | 0.65 | 100 | — | 1.20 | 1318 | Good | Good | Example of the |
| | | | | | | | | present invention |
| 33 | 0.51 | 100 | — | 1.20 | 1128 | Good | Good | Example of the |
| | | | | | | | | present invention |
| 34 | 0.53 | 96 | F | 1.26 | 1147 | Good | Good | Example of the |
| | | | | | | | | present invention |
| 35 | 0.71 | 99 | F | 1.22 | 1396 | Good | Good | Example of the |
| | | | | | | | | present invention |
| 36 | 0.59 | 99 | F | 1.24 | 1221 | Good | Good | Example of the |
| | | | | | | | | present invention |
| 37 | 0.69 | 100 | — | 1.23 | 1365 | Good | Good | Example of the |
| | | | | | | | | present invention |
| 38 | 0.44 | 95 | F | 1.24 | 1042 | Good | Good | Example of the |
| | | | | | | | | present invention |
| 39 | 0.59 | 99 | F | 1.24 | 1202 | Good | Good | Example of the |
| | | | | | | | | present invention |
| 40 | 0.35 | 97 | F | 0.91 | 962 | Good | Good | Example of the |
| | | | | | | | | present invention |
| 41 | 0.67 | 100 | — | 0.98 | 1339 | Good | Good | Example of the |
| | | | | | | | | present invention |

TABLE 4B

| | Metallographic structure of non- | | | | | | | |
|---|---|---|---|---|---|---|---|---|
| | tempered bolt | | | | | | | |
| | | Hard | | | Characteristics | | | |
| | Carbon | structure | | | Tensile | | Hydrogen | |
| | content | area fraction | Rest | β_{MAX}/β_{C} | strength | Cold | embrittlement | |
| No. | (%) | (%) | structure | (—) | (MPa) | workability | resistance | Remarks |
| 42 | 0.15 | 97 | F | 1.19 | 748 | Good | Good | Comparative |
| | | | | | | | | Example |
| 43 | 0.84 | 99 | F | 1.27 | | Poor | — | Comparative |
| | | | | | | | | Example |
| 44 | 0.66 | 98 | F | 1.33 | — | Poor | — | Comparative |
| | | | | | | | | Example |
| 45 | 0.70 | 95 | M | 1.16 | — | Poor | — | Comparative |
| | | | | | | | | Example |
| 46 | 0.60 | 96 | F | 1.21 | 1370 | Good | Poor | Comparative |
| | | | | | | | | Example |
| 47 | 0.56 | 100 | — | 1.18 | 1292 | Good | Poor | Comparative |
| | | | | | | | | Example |
| 48 | 0.71 | 100 | — | 1.12 | — | Poor | — | Comparative |
| | | | | | | | | Example |
| 49 | 0.46 | 100 | — | 1.20 | — | Poor | — | Comparative |
| | | | | | | | | Example |
| 50 | 0.65 | 84 | F | 1.26 | — | Poor | — | Comparative |
| | | | | | | | | Example |
| 51 | 0.65 | 96 | F | 1.16 | — | Poor | — | Comparative |
| | | | | | | | | Example |
| 52 | 0.46 | 100 | — | 1.25 | — | Poor | — | Comparative |
| | | | | | | | | Example |
| 53 | 0.60 | 97 | F | 1.17 | — | Poor | — | Comparative |
| | | | | | | | | Example |
| 54 | 0.58 | 95 | F, M | 1.31 | — | Poor | — | Comparative |
| | | | | | | | | Example |
| 55 | 0.62 | 96 | M | 1.15 | — | Poor | — | Comparative |
| | | | | | | | | Example |
| 56 | 0.60 | 100 | — | 1.20 | — | Poor | — | Comparative |
| | | | | | | | | Example |
| 57 | 0.69 | 100 | — | 1.18 | — | Poor | — | Comparative |
| | | | | | | | | Example |
| 58 | 0.70 | 100 | — | 1.22 | — | Poor | — | Comparative |
| | | | | | | | | Example |
| 59 | 0.68 | 100 | — | 1.30 | — | Poor | — | Comparative |
| | | | | | | | | Example |
| 60 | 0.59 | 98 | F | 1.22 | — | Poor | — | Comparative |
| | | | | | | | | Example |
| 61 | 0.71 | 98 | F | 1.23 | — | Poor | — | Comparative |
| | | | | | | | | Example |
| 62 | 0.67 | 100 | — | 1.25 | — | Poor | — | Comparative |
| | | | | | | | | Example |
| 63 | 0.63 | 99 | F | 1.29 | — | Poor | — | Comparative |
| | | | | | | | | Example |
| 64 | 0.69 | 0 | F | 1.28 | — | Poor | — | Comparative |
| | | | | | | | | Example |
| 65 | 0.46 | 24 | F, M | 1.25 | — | Poor | — | Comparative |
| | | | | | | | | Example |
| 66 | 0.65 | 98 | F | 1.52 | 1459 | Good | Poor | Comparative |
| | | | | | | | | Example |
| 67 | 0.56 | 99 | F | 1.51 | 1344 | Good | Poor | Comparative |
| | | | | | | | | Example |
| 68 | 0.28 | 100 | — | 1.16 | 791 | Good | Good | Comparative |
| | | | | | | | | Example |

*In the rest structure column, F and M mean pro-eutectoid ferrite and martensite, respectively.
*Underlined part means out of the range in the present invention or out of preferred characteristics.

All the bolts of standards 1 to 41, which are Examples of the present invention, had good hydrogen embrittlement resistance.

Each bolt of standards 42 to 63 had a chemical composition outside that of the present invention. Thus, as shown below, the bolts of standards 42 to 63 did not satisfy the tensile strength, the cold workability, and the hydrogen embrittlement resistance.

In the bolt of standard 42, the C content was out of the chemical composition of the present invention, so that the tensile strength of the bolt is outside the subject of the present invention.

Since the content of C in the bolt of standard 43 was out of the chemical composition of the present invention, cracking occurred during heading, and the tensile strength and hydrogen embrittlement resistance could not be evaluated.

In the bolts of standards 44, 48, 49, 51, 52, 53, and 56 to 63, the contents of Si, Ti, B, N, O, Nb, V, Ce, Cu, Ca, Mg, Sn, and W were out of the chemical composition of the present invention, so that cracking occurred during heading. Thus, the tensile strength and hydrogen embrittlement resistance could not be evaluated.

In the bolt of standard 50, since the content of B was out of the chemical composition of the present invention, the area fraction of the hard structure at the D/4 position deep from the surface of the shaft portion was less than 95%, and the hard structure became a non-uniform structure in which ferrite was mixed. As a result, cracking occurred during heading. Thus, the tensile strength and hydrogen embrittlement resistance could not be evaluated.

Since the contents of Mn, Cr, and Mo in the bolt of standard 45, 54, or 55 was out of the chemical composition of the present invention, cracking caused by locally generated martensite occurred during heading, and the tensile strength and hydrogen embrittlement resistance could not be evaluated.

The bolts of standards 46 and 47 did not have sufficient hydrogen embrittlement resistance because the contents of P and S were out of the chemical composition of the present invention.

The bolt of standard 64 was not subjected to the isothermal transformation treatment but subjected to air-cooling, so that the area fraction of the hard structure at the D/4 position deep from the surface of the shaft portion was less than 95%. As a result, cracking occurred during heading, and the tensile strength and hydrogen embrittlement resistance could not be evaluated.

The bolt of standard 65 had an insufficient immersion time in the molten salt bath at the time of the isothermal transformation treatment. Thus, martensite is generated during the water cooling treatment after the isothermal transformation treatment. As a result, cracking occurred during heading, and the tensile strength and hydrogen embrittlement resistance could not be evaluated.

The bolts of standards 66 and 67 underwent a cold forging step in which the step was designed so that the lower end of the expansion portion of the preformed bolt and the upper end of the finishing die cavity were brought into contact with each other when the preformed bolt was inserted into the finishing die cavity. Therefore, the ratio β_{MAX}/β_{C} of the full width at half maximum of the X-ray diffraction peak was more than 1.50, and hydrogen embrittlement resistance was insufficient.

The bolt of standard 68 had a tensile strength outside of the present invention because the wire-drawing conditions were not preferable conditions.

### INDUSTRIAL APPLICABILITY

The bolt of the present disclosure has high industrial applicability because it has a tensile strength of 800 MPa to 1700 MPa and is exceptional in hydrogen embrittlement resistance.

1. A bolt having a chemical composition comprising, in mass %,
C: 0.18 to 0.80%,
Si: 0.01 to 1.50%,
Mn: 0.50 to 2.00%,
Al: 0.005 to 0.080%,
P: 0.030% or less,
S: 0.030% or less,
Ti: 0.005 to 0.100%,
B: 0.0003 to 0.0050%,
N: 0.0150% or less,
O: 0.0100% or less, and
a balance: Fe and impurities, wherein
when a diameter of a shaft portion is D, 95% or more of a metallographic structure at a D/4 position is a hard structure;
when β_{C} is a full width at half maximum of a X-ray diffraction peak corresponding to a (211) plane of ferrite at a center of the shaft portion of a connection portion between a bolt head portion and the shaft portion and β_{MAX} is a maximum value of the full width at half maximum of the X-ray diffraction peak corresponding to the (211) plane of the ferrite in a region from a surface of the connection portion to a depth of 500 μm toward a central axis of the shaft portion, a ratio β_{MAX}/β_{C} is 1.50 or less; and
a tensile strength is from 800 to 1700 MPa.

2. A bolt having a chemical composition comprising, in mass %,
C: 0.18 to 0.80%,
Si: 0.01 to 1.50%,
Mn: 0.50 to 2.00%,
Al: 0.005 to 0.080%,
P: 0.030% or less,
S: 0.030% or less,
Ti: 0.005 to 0.100%,
B: 0.0003 to 0.0050%,
N: 0.0150% or less, and
O: 0.0100% or less,
the composition further comprising
one or two or more elements selected from the group consisting of group A, group B, and group C below,
with a balance consisting of Fe and impurities, wherein
when a diameter of a shaft portion is D, 95% or more of a metallographic structure at a D/4 position is a hard structure;
when β_{C} is a full width at half maximum of a X-ray diffraction peak corresponding to a (211) plane of ferrite at a center of the shaft portion of a connection portion between a bolt head portion and the shaft portion and β_{MAX} is a maximum value of the full width at half maximum of the X-ray diffraction peak corresponding to the (211) plane of the ferrite in a region from a surface of the connection portion to a depth of 500 μm toward a central axis of the shaft portion, a ratio β_{MAX}/β_{C} is 1.50 or less; and
a tensile strength is from 800 to 1700 MPa:
[group A] one or two or more elements selected from the group consisting of Cr: 1.50% or less, Mo: 0.50% or less, Nb: 0.050% or less, V: 0.20% or less, and W: 0.20% or less;
[group B] one or two elements selected from the group consisting of Cu: 0.50% or less and Ni: 0.50% or less; and
[group C] one or two or more elements selected from the group consisting of Ca: 0.0100% or less, Mg: 0.0100% or less, Ce: 0.020% or less, and Sn: 0.0400% or less.

3. The bolt according to claim 2, having the chemical composition comprising the group A in mass %.

4. The bolt according to claim 2, having the chemical composition comprising the group B in mass %.

5. The bolt according to claim 2, having the chemical composition comprising the group C in mass %.
